(19) United States
(12) Patent Application Publication
(10) Pub. No.: US 2024/0289626 A1
(43) Pub. Date: Aug. 29, 2024

(54) SYSTEMS AND METHODS FOR STRESS DETECTION USING KINEMATIC DATA

(71) Applicant: Board of Regents, The University of Texas System, Austin, TX (US)

(72) Inventors: Ann MAJEWICZ FEY, Austin, TX (US); Yi ZHENG, Austin, TX (US)

(73) Assignee: Board of Regents, The University of Texas System, Austin, TX (US)

(21) Appl. No.: 18/436,313

(22) Filed: Feb. 8, 2024

Related U.S. Application Data
(60) Provisional application No. 63/484,393, filed on Feb. 10, 2023.

(51) Int. Cl. G06N 3/084; G06N 3/0442

(52) U.S. Cl. CPC G06N 3/084; G06N 3/0442

(57) ABSTRACT

Devices, systems and methods to detect stress using kinematic data are disclosed herein. In certain embodiments a spatial attention mechanism is used to describe the contribution of each kinematic feature to the classification of normal/stressed movements. Some embodiments comprise determining if the kinematic data from a user belong to a class of sub-movements associated with known signatures found to highly correlate with when the user is experiencing motor degradation due to high psychological stress versus a normal class of movements where the user is unaffected by stress.

### CROSS-REFERENCE TO RELATED APPLICATIONS

This application claims priority to U.S. Provisional Patent Application No. 63/484,393 filed Feb. 10, 2023, the entire contents of which are incorporated herein by reference.

### GOVERNMENT SUPPORT CLAUSE STATEMENT

This invention was made with government support under Grant No. R01 EB030125 awarded by the National Institutes of Health, and Grant No. CMMI1846726 and CMMI2024839 awarded by the National Science Foundation. The government has certain rights in the invention.

### BACKGROUND INFORMATION

Increased levels of stress can impair surgeon performance and patient safety during surgery. The aim of this study is to investigate the effect of short term stressors on laparoscopic performance through analysis of kinematic data. Thirty subjects were randomly assigned into two groups in this IRB-approved study. The control group was required to finish an extended-duration peg transfer task (6 minutes) using the FLS trainer while listening to normal simulated vital signs and while being observed by a silent moderator. The stressed group finished the same task but listened to a period of progressively deteriorating simulated patient vitals, as well as critical verbal feedback from the moderator, which culminated in 30 seconds of cardiac arrest and expiration of the simulated patient. For all subjects, video and position data using electromagnetic trackers mounted on the handles of the laparoscopic instruments were recorded. A statistical analysis comparing time-series velocity, acceleration, and jerk data, as well as path length and economy of volume was conducted. Clinical stressors lead to significantly higher velocity, acceleration, jerk, and path length as well as lower economy of volume. An objective evaluation score using a modified OSATS technique was also significantly worse for the stressed group than the control group. This study shows the potential feasibility and advantages of using the time-series kinematic data to identify the stressful conditions during laparoscopic surgery in near-real-time. This data could be useful in the design of future robot-assisted algorithms to reduce the unwanted effects of stress on surgical performance.

Performing surgery is stressful. Surgeons have to maintain continuous attention to detail while performing intricate tasks. Intraoperative stressors (FIG. 1) may include fatigue, disruptions, teamwork issues, time pressure, surgical complexity, high risk patients, and unexpected complications [1]. In addition, different types of surgery can be inherently more stressful to perform than others. For example, laparoscopic surgery has limitations in visualization, workspace volume, and an increased need for hand-eye coordination [2]-[4].

When it comes to robotic surgery, results are mixed in terms of measured surgeon stress levels using galvanic skin response when compared to either open surgery or virtual reality simulators, however, in neither study are the differences statistically significant [5], [6]. For complex motor tasks, it has been shown that external stressors can adversely affect motor performance [7]. The negative effects of stress on surgical performance include higher number of errors, less motion economy, and increased completion time [8]-[11].

It has been shown that senior surgeons are able to develop stress management strategies that decrease the negative effect of stress on their performance, over time [12]-[15]. However; it is not fully understood how, specifically, those strategies change motor performance and how that information might be useful in the design of training platforms or feedback algorithms to detect and assist surgical trainees who experience stress while learning surgical tasks.

Physiological sensing is the most direct and traditional measure of stress (e.g., heart rate, skin conductance level). However, it also requires surgeons to wear sensors which could potentially interfere with surgeon's performance. In this study, we characterize the effect of clinical stress on surgical performance using a variety of kinematic metrics. Our long-term goal is to find kinematic markers associated with intraoperative stress that could be used to detect surgeon stress levels in real-time so as to mitigate the potential risk to the patient through the development of advanced control techniques on robotic-surgical platforms.

### SUMMARY

Exemplary embodiments of the present disclosure include systems and methods for extracting representative normal and stressed movements for real-time detection purposes, including for example, during movements performed during laparoscopic surgical procedures. Exemplary embodiments disclosed herein can be used to determine which kinematic feature is more likely to be affected by stress for stress mitigation purposes.

It has been well studied that psychological stress can affect motor performance. With the right training data, methods could potentially be used to detect stress onset and eventually provide meaningful feedback to humans in other complex motor tasks such as in sports coaching or highly-skilled manual manufacturing tasks.

We proposed framework using an attention-based Long-Short-Term-Memory classifier to extract the surgical movements which are more likely to be affected surgical stress. And another classifier to distinguish between normal and stressed surgical movement. The classifiers could potentially be integrated with robotic-assisted surgery platforms for stress management purposes.

Exemplary embodiments of the present disclosure utilize kinematic data to detect stress levels instead of physiological sensing (heart rate, etc.). Exemplary embodiments disclosed herein extract stressed movement using kinematic data during surgical training tasks and can be used for stressed movement detection during surgical procedures.

Exemplary embodiments do not require user to wear additional sensors which could interfere with user's performance.

Exemplary embodiments of the present disclosure include a method for stress detection using kinematic data, wherein the method comprises: inputting the kinematic data into a model; determining if the kinematic data from a user belong to a class of sub-movements associated with known signatures found to highly correlate with when the user is experiencing motor degradation due to high psychological stress versus a normal class of movements where the user is unaffected by stress; and training the model by iteratively updating parameters of the model to minimize error between a prediction and a ground-truth label through backpropagation. In certain embodiments of the method, the parameters comprise weights and biases. In particular embodiments of the method, the weights and biases are in cells of a long-short-term-memory (LSTM) recurrent neural network. In some embodiments of the method, the weights and biases are in fully-connected layers.

In specific embodiments of the method the backpropagation comprises: (1) inputting the kinematic data to the model to make the prediction; (2) calculating the error between the prediction and the ground-truth label; (3) propagating the error backwards through the LSTM recurrent neural network and fully-connected layers; and (4) updating the weights and biases of the model using optimization methods. Certain embodiments of the method further comprise repeating steps (1)-(4) multiple times. In particular embodiments of the method, steps (1)-(4) are repeated until the error between the prediction and ground-truth label in minimized.

In specific embodiments of the method, an importance is assigned to different time steps in an input sequence of kinematic data. In certain embodiments of the method, the importance is assigned to different time steps in the input sequence of kinematic data based on the relevance of the weights and biases to a final classification task.

Exemplary embodiments of the present disclosure also comprise a system for stress detection using kinematic data, wherein the system if configured to: input the kinematic data into a model; determine if the kinematic data from a user belong to a class of sub-movements associated with known signatures found to highly correlate with when the user is experiencing motor degradation due to high psychological stress versus a normal class of movements where the user is unaffected by stress; and train the model by iteratively updating parameters of the model to minimize error between a prediction and a ground-truth label through backpropagation.

In particular embodiments of the system, the parameters comprise weights and biases. In some embodiments of the system, the weights and biases are in cells of a long-short-term-memory (LSTM) recurrent neural network. In specific embodiments of the system, the weights and biases are in fully-connected layers. In certain embodiments, the system is configured to perform the backpropagation by: (1) inputting the kinematic data to the model to make the prediction; (2) calculating the error between the prediction and the ground-truth label; (3) propagating the error backwards through the LSTM recurrent neural network and fully-connected layers; and (4) updating the weights and biases of the model using optimization methods.

In particular embodiments the system is configured to repeat steps (1)-(4) multiple times. In some embodiments the system is configured to repeat steps (1)-(4) until the error between the prediction and ground-truth label in minimized. In specific embodiments the system is configured to assign an importance to different time steps in an input sequence of kinematic data. In particular embodiments the system is configured to assign the importance to different time steps in the input sequence of kinematic data based on the relevance of the importance to a final classification task, including also detecting signatures associated with stress onset that enhance performance rather than degrade it.

In the present disclosure, the term “coupled” is defined as connected, although not necessarily directly, and not necessarily mechanically.

The use of the word “a” or “an” when used in conjunction with the term “comprising” in the claims and/or the specification may mean “one,” but it is also consistent with the meaning of “one or more” or “at least one.” The terms “approximately, “about” or “substantially” mean, in general, the stated value plus or minus 10%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will be apparent to those skilled in the art from this detailed description.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1 illustrates a simulated operating room configured to obtain data according to an exemplary embodiment of the present disclosure. Stresses in the operating room include both those associated with the patient status, as well as those associated with being a surgical trainee, who is directed and evaluated by an expert surgeon.

FIGS. 2a-c illustrate a apparatus and methods used to obtain data according to an exemplary embodiment of the present disclosure.

FIGS. 3a-b illustrate data displaying normal and deteriorating vital signs provided during tests to obtain data according to an exemplary embodiment of the present disclosure. Example normal and deteriorating vital signs during this experiment. Deteriorating vitals included increasing Heart Rate (HR), and decreasing Pulse, Blood Oxygen Level (SpO2), Blood Pressure (ABP), End-tidal CO2 (etCO2) and Respiratory Rate (awRR).

FIGS. 4a-c illustrate kinematic results data for velocity, acceleration, and jerk for subjects during tests to obtain data according to an exemplary embodiment of the present disclosure.

FIGS. 5a-f illustrate static results data for subjects during tests to obtain data according to an exemplary embodiment of the present disclosure.

FIG. 6 illustrates a model architecture of attention-based long short-term memory (LSTM) classifier for trial-wise classification and movement extraction based on attention according to an exemplary embodiment of the present disclosure.

FIG. 7 illustrates and example of using sliding windows to organize the sequential data according to an exemplary embodiment of the present disclosure. The purple rectangles indicate the frames and an overlap of 50% between dashed (frame t−1) and solid (frame 1) rectangles.

FIG. 8 illustrates a visualization of attention of an example stressed trial according to an exemplary embodiment of the present disclosure. Top: a heat map colorizes the magnitude of attention at each time step. Bottom: the time-series positions of both instrument handles.

FIG. 9 illustrates a comparison between the attention of first and second three minutes in control (normal) and stressed trials according to an exemplary embodiment of the present disclosure. The second three minutes in stressed trials are associated with higher attention.

FIG. 10 illustrates an example of ground-truth labeling for stressed trials with a frame size of 8 second and an overlap of 50% (subject 14) according to an exemplary embodiment of the present disclosure.

FIG. 11 illustrates the change from trait to state with higher scores in the stressed group according to an exemplary embodiment of the present disclosure.

FIG. 12 illustrates model architecture of proposed spatial attention-based LSTM classifier for representative movements classification and the extraction of input feature importance according to an exemplary embodiment of the present disclosure. Model architecture of proposed spatial attention-based LSTM classifier for “representative” movements classification and the extraction of input feature importance. The input had 6 features including time-series velocity, acceleration, and jerk of both instrument tips.

FIGS. 13a-b illustrate graphs comparing the spatial attention of different kinematic features in normal and stressed movements according to an exemplary embodiment of the present disclosure.

FIGS. 14a-b illustrates graphs comparing the sum of spatial attention between non-dominant hand side and dominant hand side for characterizing a normal and stressed movement according to an exemplary embodiment of the present disclosure.

FIG. 15 illustrates a flowchart of the steps for using normal and stressed trial data to obtain a representative normal and representative stressed model for training a new classifier according to an exemplary embodiment of the present disclosure.

FIG. 16 illustrates sensor data and movement models can be used for feedback and guidance to a user according to an exemplary embodiment of the present disclosure.

### DETAILED DESCRIPTION OF EXEMPLARY EMBODIMENTS

Exemplary embodiments of the present disclosure are configured to identify and utilize kinematic markers associated with intraoperative stress during surgical training tasks by better understanding the effects of stress on surgical movements.

Several studies have described how stress can affect surgical performance and there are a variety of sensors and analysis methods to measure physiological stress.

### Effect of Stress on Surgical Performance and Outcomes

Performance Measurements: The Objective Structured Assessment of Technical Skill (OSATS) was developed and evaluated as a method of surgical technical skill assessment. The OSATS has shown its promise as a reliable method for testing operative skills in surgical trainees [16]. However, OSATS needs reviewer's rating and the resulting scores may be varied in different reviewers. Alternatively, task-independent metrics (e.g., time, path length, smoothness, depth perception) extracted from the analysis of the laparoscopic instruments motions has been introduced as a technically sound approach for surgical performance assessment [17]. Several approaches of motiontracking in laparoscopic surgery have been introduced, including electromagnetic sensors, optical and camera trackers. These studies demonstrated the potential feasibility of the kinematic data to access laparoscopic psychomotor skills using motion-based metrics such as path length, speed, or economy of volume [18]-[21]. The kinematic data was also adopted for evaluating surgical performance during robotics surgical training tasks, and it demonstrated the ability of objectively distinguishing between novice and expert performance as well as the training effects in the performance of training tasks [22].

The Effect of Stress on the Performance: Excessive levels of stress can compromise surgical performance [8]. The stressors led to impaired dexterity by showing an increased path length and a higher number of errors when the subject was under stressful conditions [9]. The cognitive distraction has been shown to have negative effects on the performance, such as a significantly greater time to task completion when subjects were distracted, and the overall score and economy of motion were negatively affected by distraction but did not reach the level of statistical significance [10]. Furthermore, higher levels of stress correlated with increased completion time, lower economy of motion, and an increased number of errors [11]. However, none of these prior studies investigate pure kinematic metrics in depth.

### Tools and Techniques for Measuring Stress

Traditional measures of stress includes self-report of stress level [2], [8], and physiological sensing such as heart rate (HR) or heart rate variance (HRV), skin conductance level (SCL), and electrooculogram (EOG). Studies showed that all these physiological measures were increased by stressful conditions [2], [23]-[27]

However, self-report questionnaires are subjective and the physiological sensing systems are invasive since these technologies require wearable sensors which might interfere with the subject's performance. In this study, we would like to exploit the less invasive measurement—kinematic data—to identify the effect of stress during surgical training. In addition to being less invasive, kinematic data is inherently accessible on robotic laparoscopic surgery platforms, though maybe not yet easily available to research teams. Regardless, it has been shown that the kinematic data be used to predict expertise levels during training tasks on robotic-assisted surgical platforms [28]-[30]. By integrated the detection of stress with these robotic control platforms, there may be exciting opportunities to mitigate adverse effects of stress through robotic controls. This paper lays the groundwork for identifying kinematic markers of intraoperative stress.

### EXPERIMENTAL DESIGN

### Simulator Hardware

FLS Trainer: The FLS (Fundamentals of Laparoscopic Surgery) trainer is a portable box trainer with a soft cover that can simulate the human abdomen. The trainer has 2 port holes for the laparoscopic instruments (FIG. 2a) and a camera under the cover to simulate the laparoscopic camera and provides a field of vision (FIG. 2c).

Electromagnetic Trackers: The electromagnetic trackers (Ascension 3D Guidance trakSTAR) were used to capture real-time data. The electromagnetic trackers were mounted to the handles of the tools using a pair of 3D printed adapters (FIG. 2a) and used to obtain the x, y, z positions of the tool tips using a rigid body transformation and the geometry of the tools.

### Clinical Stressor

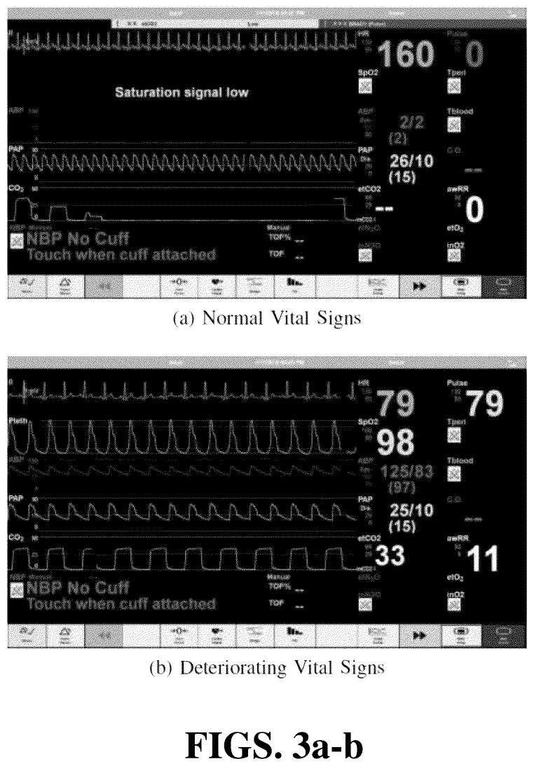

In this study, the stressors included the vital signs from the monitor as well as the moderator's feedback. The vital signs are shown in FIG. 3.

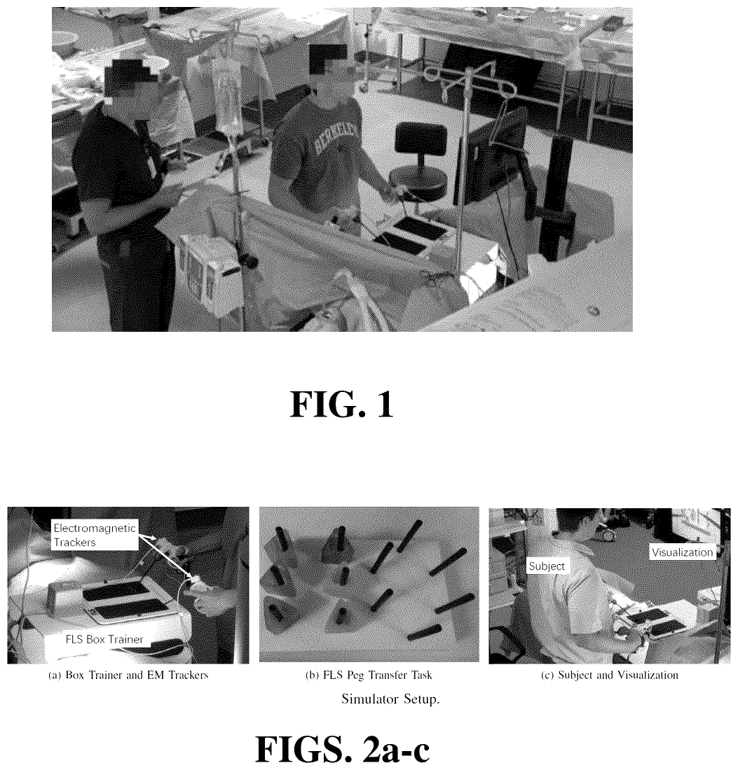

The moderator provided feedback to an illusory anesthesiologist and nurse circulator of the increased danger of the dummy patient and the need for adjunctive treatments such as intravenous fluids and blood transfusions (FIG. 1) to simulate a busy and stressful operating room. Some feedback was directed at the participating subject to complete the task more quickly.

### Surgical Training Task

The extended duration (e.g., 6 minutes) bimanual peg transfer drill was conducted using the FLS trainer as shown in FIG. 2b. The subjects were required to pick up the pegs and transfer them to another hand from one side on the board to another. The goal was to transfer as many blocks as possible whilst committing the fewest possible errors. Errors were defined as dropping a block or breaking a rule of transfer.

### Methods

### Subject Recruitment

Thirty users were recruited for this study. The subjects were medical students at the University of Texas Southwestern Medical Center in classes 1 through 4. Twenty-nine out of thirty participants were right-handed and 1 was left-handed. The study protocol was approved by UTD IRB office (UTD #14-57). Participants had no previously reported muscular-skeletal injuries or diseases, or neurological disorders.

### Experimentation

Each subject participated in several baseline surveys including a background questionnaire. Next, the subjects participated in a 10-minute tutorial on the fundamentals of laparoscopic (FLS) peg transfer drill to familiarize them with the instruments and with the requirements of the experimental task. In order to prevent bias, the subjects were randomized after the tutorial to the stressed or control group.

The experiment took place in a high-fidelity simulated operating room. The FLS peg transfer platform was placed in the abdominal section of a medical dummy which was draped. The vital sign monitor was in plain view. Several cameras recorded video from the experiment to capture images of the instrument tips and blocks, subject posture and the general environment.

The control group conducted the extended duration peg transfer task while hearing normal vital signs (FIG. 3a) from the monitor for the duration of their task. The moderator did not provide any feedback on their performance. The stressed group performed under a period of progressively deteriorating vital signs (FIG. 3b) with a particular increase in intensity beginning at the three-minute mark. The moderator also provided feedback to the stressed group and the feedback culminated in 30 seconds of cardiac arrest and the expiration of the dummy patient, occurring simultaneously with the end of stressed six-minute task.

### Data Analysis

All objective metrics of performance were based on the kinematic features of the tool tips. The tip positions were calculated using EM tracker positions and a rigid body transformation using the tool geometry.

Data Acquisition: The kinematic data was streamed and recorded from the EM trackers through ROS topics [31]. In this study, the kinematic features including the x-, y-, z-positional coordinates in space and quaternions x-, y-, z-, w-were collected. The positional coordinates determined the tool positions in space and the quaternions were used to determine the rotation matrix for calculating the 3 dimensional tool tip positions (P=[Px; Py; Pz]^{T}).

Data Processing: The kinematic data was recorded at a frequency of 256 Hz from the EM trackers. In order to reduce the noise and improve computational efficiency, after calculating the tool tip positions, we used an established method to down-sample the kinematic data to 5 Hz using a cubic spline to enforce a constant sampling rate between data points, therefore, smoothed the data for kinematic metrics calculation [22].

Kinematic Metrics: The kinematic metrics included velocity (V), acceleration (A), jerk (J), Path Length (PL) and the Economy of Volume (EV) of the tool tip.

The Velocity (V) was time series data calculated as follows:

$${V}_{t} = \frac{\sqrt{{( {P}_{t + 1} - {P}_{t} )}^{T} ( {P}_{t + 1} - {P}_{t} )}}{{T}_{t + 1} - {T}_{t}} \qquad ( 1 )$$

Pt is the 3-D position at time t, and Tt is the time stamp a time t The Acceleration (A) and the jerk (J) were time series data calculated in the similar way:

$${A}_{t} = \frac{{V}_{t + 1} - {V}_{t}}{{T}_{t + 1} - {T}_{t}} , {J}_{t} = \frac{{A}_{t + 1} - {A}_{t}}{{T}_{t + 1} - {T}_{t}} \qquad ( 2 )$$

The Path Length (PL) is the sum of the displacement at each time point and it indicates the total length traveled. This parameter describes the spatial distribution of the tip of the laparoscopic instrument in the work space of the task. A compact “distribution” is characteristic of an expert [17]:

$$PL = {\sum }_{{T}_{start}}^{{T}_{end}} \sqrt{{( {P}_{t + 1} - {P}_{t} )}^{T} ( {P}_{t + 1} - {P}_{t} )} \qquad ( 3 )$$

The Economy of Volume (EV) is a single-value data indicating the efficiency of occupying the space [20], and a larger value of EV indicates a better performance:

$$E V = \frac{\sqrt[3]{( {x}_{max} - {x}_{min} ) ( {y}_{max} - {y}_{min} ) ( {z}_{max} - {z}_{min} )}}{PL} \qquad ( 4 )$$

4) Video Review: Besides the kinematic metrics, video review was conducted to include measurement of the counts of blocks transferred (N) and errors committed (Er). Additionally, a blinded, independent reviewer with training in OSATS scoring graded each subject using a modified OSATS (mOSATS) rubric. The subsections included in scoring were respect for tissue (RFT), time and motion (TM), instrument handling (IH) and the total score (TOT). Each of these scores ranged from 1 to 5, with 5 representing the best and 1 the worst performance.

### Analysis Methods

We examined the distribution properties of all the metrics mentioned above.

The time series data of Velocity, Acceleration and Jerk were non-gaussian distributed while the other metrics (statics data) such as Path Length, Economy of Volume and mOSATS scores were gaussian distributed. According to Section IV-B, the experiment length was 6 minutes and the stressed group was experiencing the clinical stress which progressively increased its intensity at 3-minute mark and culminated at the end of the task. Therefore, we divided the collected data into two halves (H1 vs. H2) and ideally, the stress should show more effect in the second half. Therefore, in order to study the significant effect of the stress, we first compared the data of the second half between Control and Stressed Groups, then the data of Stressed Group between First and Second Halves.

Therefore, according to data distribution properties and data dependencies, as summarized in Table I, we used different methods for statistical analysis.

TABLE I
Summary of the statistical analysis methods for different data.

| | Statistical | |
|---|---|---|
| Comparisons | Analysis Methods | Applied to |
| Time Series Data | Mann-Whitney | Table II |
| between Groups | U-test | |
| (Non-Gaussian distributed, | | |
| independent) | | |
| Static Data between | Independent t-test | Table IV |
| Groups (Gaussian | | |
| distributed, independent) | | |
| Time Series Data between | Wilcoxon signed | Table III |
| Halves in Stressed Group | rank test | |
| (Non-Gaussian distributed, | | |
| dependent) | | |
| Static Data between | Dependent t-test | Table V |
| Halves in Stressed Group | | |
| (Gaussian distributed, dependent) | | |

### RESULTS

Control Group vs. Stressed Group

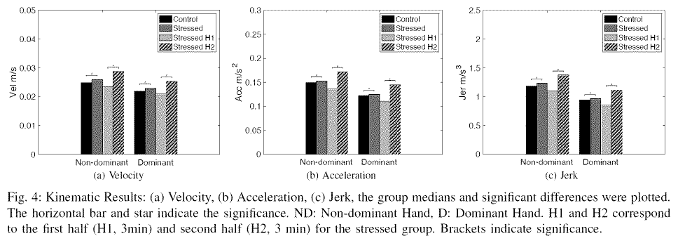

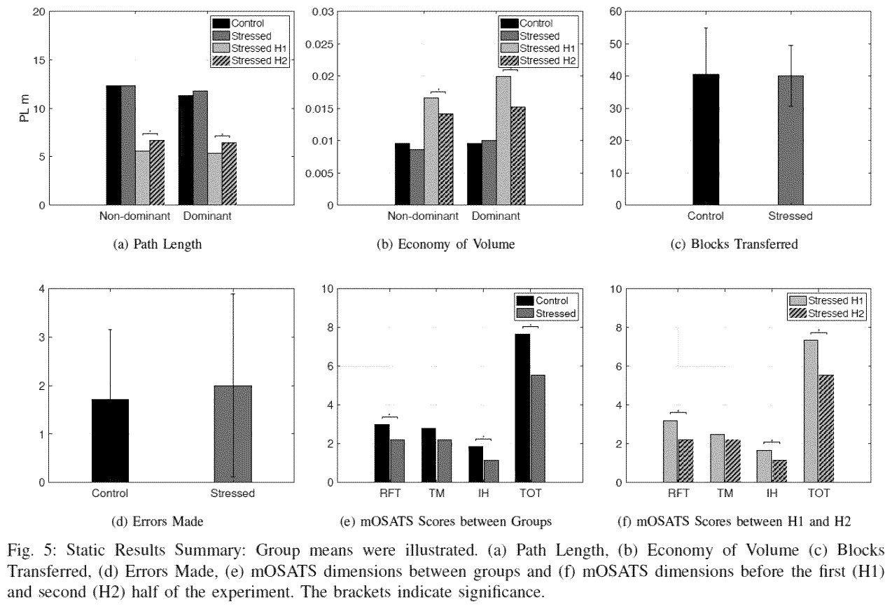

The results of comparisons between stressed and control groups are shown in Table II. Table IV. FIG. 4 and FIG. 5.

TABLE II
Comparison of Velocity, Acceleration and Jerk between
Control and Stressed Groups using Mann Whitney U-test.

| Metrics | Hand | Control vs. Stressed (median[IQR]) | p |
|---|---|---|---|
| V | ND | 0.0249[0.0329] < 0.0260[0.0329] | 0.0125 |
| | D | 0.0218[0.0327] < 0.0229[0.0340] | <0.0001 |
| A | ND | 0.1495[0.1854] < 0.1526[0.1918] | 0.0396 |
| | D | 0.1222[0.1793] < 0.1245[0.1832] | 0.0016 |
| J | ND | 1.1856[1.3909] < 1.2326[1.4681] | <0.0001 |
| | D | 0.9411[1.3196] < 0.9666[1.3780] | <0.0001 |

ND: Nondominant Hand, D: Dominant Hand.

TABLE III
Comparison of Velocity, Acceleration and Jerk between First and
Second Halves in Stressed groups using Wilcoxon signed rank test.

| Metrics | Hand | Stressed H1 vs. H2 (median[IQR]) | p |
|---|---|---|---|
| V | ND | 0.0236[0.0302] < 0.0287[0.0358] | <0.0001 |
| | D | 0.0209[0.0308] < 0.0253[0.0373] | <0.0001 |
| A | ND | 0.1361[0.1754] < 0.1715[0.2072] | <0.0001 |
| | D | 0.1107[0.1583] < 0.1446[0.2065] | <0.0001 |
| J | ND | 1.1037[1.3493] < 1.3758[1.5879] | <0.0001 |
| | D | 0.8543[1.1984] < 1.1193[1.5584] | <0.0001 |

ND: Nondominant Hand, D: Dominant Hand.

For kinematic metrics, stressed group has greater Velocity (Non-dominant Hand: p<0.0125, Dominant Hand: p<0.0001), Acceleration (Non-dominant Hand: p=0.0396, Dominant Hand: p=0.0016), and Jerk (Non-dominant Hand: p<0.0001, Dominant Hand: p<0.0001) than control group for both hands. However, Path Length (Nondominant Hand: p=0.9772, Dominant Hand: p=0.6467) and Economy of Volume (Non-dominant Hand: p=0.2434 vs. Dominant Hand: p=0.6596) cannot show significant difference between groups.

For mOSATS scores, control group has greater score values than stressed group in metrics Respect for Tissue (RFT: p=0.0198), Instrument Handling (IH: p=0.0158) and the Total Score (TOT: p=0.0067) which means better performance in control group.

Even though metrics of path length, economy of volume, number of blocks, number of errors and mOSATS-TM score cannot show significance between groups, the desired trend can be found, i.e. more blocks transferred (FIG. 5c), less errors made (FIG. 5d), and greater mOSATs scores (FIG. 5e) in the control group.

First Half Vs. Second Half of Stressed Group

We also studied the effect of the intensity of stress. We analyzed the performance of stressed group between the first and the second half of the experiment, as shown in Table III, Table V, FIG. 4 and FIG. 5. The effect of increasingly intensive stress are significant.

The second half which is with more intensive stress, has greater Velocity, Acceleration, Jerk, Path Length and lower Economy of Volume.

mOSATS scores between the two halves also support the kinematic metrics. The first half has significantly greater score values than the second half in metrics Respect for Tissue (RFT), Instrument Handling (IH) and the Total Score (TOT).

TABLE IV
Comparison of Static Metrics (Path Length, Economy of Volume,
mOSATS scores, number of blocks transferred, number of errors made)
between Control and Stressed groups using independent t-test.

| Metrics | Hand | Control vs. Stressed (mean(SD)) | p |
|---|---|---|---|
| PL | ND | Not Significant | 0.9772 |
| | D | Not Significant | 0.6467 |
| EV | ND | Not Significant | 0.2434 |
| | D | Not Significant | 0.6596 |
| mOSATS- | | 3(1.1767) > 2.2(0.4140) | 0.0198 |
| RFT | | | |
| mOSATS- | | Not Significant | 0.1250 |
| TM | | | |
| mOSATS- | | 1.8571(1.0271) > 1.1333(0.3519) | 0.0158 |
| IH | | | |
| mOSATS- | | 7.6429(2.5603) > 5.5333(1.0601) | 0.0067 |
| TOT | | | |
| # of Blocks | | Not Significant | 0.9234 |
| # of Errors | | Not Significant | 0.6522 |

ND: Nondominant Hand, D: Dominant Hand.

TABLE V
Comparison of Static Metrics (Path Length,
Economy of Volume, mOSATS scores) between first and
second halves in stressed group using dependent t-test.

| Metrics | Hand | Stressed H1 vs. Stressed H2 (mean(SD)) | p |
|---|---|---|---|
| PL | ND | 5.5895(1.4606) < 6.6961(1.3887) | <0.0001 |
| | D | 5.3662(1.1530) < 6.4489(1.1453) | <0.0001 |
| EV | ND | 0.0166(0.0033) > 0.0142(0.0019) | 0.0014 |
| | D | 0.0200(0.0048) > 0.0152(0.0040) | 0.0035 |
| mOSATS- | | 3.2000(1.0823) > 2.2000(0.4140) | 0.0017 |
| RFT | | | |
| mOSATS- | | Not Significant | 0.2620 |
| TM | | | |
| mOSATS- | | 1.6667(0.7237) > 1.1333(0.3519) | 0.0148 |
| IH | | | |
| mOSATS- | | 7.3333(1.6762) > 5.5333(1.0601) | <0.0001 |
| TOT | | | |

ND: Nondominant Hand, D: Dominant Hand.

However, the mOSATS-TM (Time and Motion) metrics failed to show significant results in evaluating the subject movement as shown in Table IV and Table V. Therefore, according to our analysis, the kinematic metrics show potential advantages for evaluating the effect of stress over the method of mOSATS.

### Discussion

Prior work has shown that experts have significantly greater velocity than pre-trained novices which means a better performance [22]. However, according to our results, mOSATS successfully showed that the stressed group had worse performance as well as greater velocities. Some limitations of our study is that this was a simple peg transfer task performed by medical students, meaning our results lack a wide range of expertise levels. Regardless, our results suggest the importance of further investigate the role of velocity in detecting both stress and expertise. Future studies with more complicated surgical training tasks and subjects of different expertise levels should be conducted to better interpret the underlying properties of movement velocity.

Our results also agree with prior work that lower jerk values describe a better performance [17]. The metric of economy of volume failed to show significant difference between control and stressed groups which is consistent with prior results that motion economy didn't have statistical significance between distracted and undistracted groups [10].

### CONCLUSION

In this study, we exposed subjects to commonly experienced clinical stressors during surgical operation. Our results show that both kinematic metrics and mOSATS scores showed significant differences between the control and stressed groups. The clinical stressors had a negative effect on surgical performance, as measured by the mOSATS scores, and our kinematic metrics of velocity, acceleration, jerk, path length, and economy of volume are also negatively impacted by stress conditions for both the dominant and nondominant hands. To be more specific, the stressed group's movement is less smooth but faster than the control group.

Overall the stress group resulted in lower mOSATS scores and the control group had better performance in treating the tissue, and handling and moving with the instruments relative to the stressed group.

We also found the shortcomings of using mOSATS to evaluate the effect of surgical stress. The metric of mOSATSTM, which was designed to assess the subject motion during surgical training, wasn't able to evaluate the effect of stress on subject movement. Kinematic metrics show an advantage in evaluating the effect on movement over the mOSATS dimensions alone.

Since both methods of mOSATS and kinematic analysis can evaluate the performance under stress conditions, future studies should investigate the correlation between mOSATS scores and different kinematic metrics. And potentially, finding novel metrics which can respectively interpret mOSATS scores could enable automatic collection for mOSATS scores from kinematic features.

This study can serve as the groundwork for future work to providing preventative control strategies to reduce the unwanted effect of stress during surgical training, consequently, improving surgical training outcomes and patient safety. In future work, we will implement the real-time detection of experienced stress using kinematic data. The detection of stress could trigger haptic cues on robotic-assisted surgery platform to provide stress coping strategies, such as pausing and slowing down, to mitigate the negative effect of excessive stress [1].

### Frame-Wise Detection of Surgeon Stress Levels During Laparoscopic Training Using Kinematic Data

Purpose: Excessive stress experienced by the surgeon can have a negative effect on the surgeon's technical skills. The goal of this study is to evaluate and validate a deep learning framework for real-time detection of stressed surgical movements using kinematic data.

Methods: 30 medical students were recruited as the subjects to perform a modified peg transfer task and were randomized into two groups, a control group (n=15) and a stressed group (n=15) that completed the task under deteriorating, simulated stressful conditions. To classify stressed movements, we first developed an attention-based Long-Short-Term-Memory recurrent neural network (LSTM) trained to classify normal/stressed trials and obtain the contribution of each data frame to the stress level classification. Next, we extracted the important frames from each trial and used another LSTM network to implement the frame-wise classification of normal and stressed movements.

Results: The classification between normal and stressed trials using attention-based LSTM model reached an overall accuracy of 75.86% under Leave-One-User-Out (LOUO) cross-validation. The second LSTM classifier was able to distinguish between the typical normal and stressed movement with an accuracy of 74.96% with an 8-second observation under LOUO. Finally, the normal and stressed movements in stressed trials could be classified with the accuracy of 68.18% with a 16-second observation under LOUO.

Conclusion: In this study, we extracted the movements which are more likely to be affected by stress and validated the feasibility of using LSTM and kinematic data for frame-wise detection of stress level during laparoscopic training. The proposed classifier could potentially be integrated with robot-assisted surgery platforms for stress management purposes.

### INTRODUCTION

Intra-operative surgical stress is commonly experienced by surgeons. Acute mental stress can compromise surgical skill and in turn, affect patient safety [34]. During laparoscopic procedures, it has also been shown that surgeons experience more stressful conditions than during open surgery due to limitations in visualization, work space volume, and an increased need for hand-eye coordination. [36]. Performing laparoscopic surgery is a complex motor task. For complex tasks, it has been shown that external stressors can adversely affect motor performance [54]. The negative effects of external stress on surgical performance can include a higher number of errors made, less economy of motion, and increased completion time [33,34,43,50].

Measuring Stress Level Excessive stress can have negative effects on a surgeon's technical skills, for example, leading to increased path length and a higher number of errors [50]. A common established method for measuring human stress levels involves the use of physiological data. Cortisol levels measured from saliva have been well studied As indicators of stress [34]. Heart rate, heart rate variability, and skin conductance level also can be used to quantify stress levels [37,38,40,56]. However, these techniques can be time consuming, are relatively invasive, and may require surgeons to wear additional sensors on their bodies that may be cumbersome. Alternatively, in our previous studies, we validated the feasibility of using features extracted from kinematic data of the laparoscopic instrument tips (e.g., velocity, acceleration, and jerk) to distinguish between stressed and non-stressed conditions during laparoscopic training procedures using statistical analysis. These studies demonstrated that the kinematic data is a powerful tool for identifying stressed conditions. Additionally, kinematic data measuring techniques are less invasive than physiological sensing as they require fewer sensors that do not need to be worn by the surgeon [46,61].

### Demand for Real-Time Detection of Stress Level

Stress levels can vary during laparoscopic surgery and stress may come from different sources [32]. The aforementioned sensing techniques often measurements after the experimental trial. Continuous stress monitoring, however, could enable more granular stress-related data. For example, Weenk et al. [59] implemented continuous stress monitoring using a wearable sensor patch which monitored the heart rate variability (HRV) of surgeons. HRV analysis requires both time domain and frequency domain techniques, as well as collecting the baseline data from each subject, which can be computationally challenging. There is an important need to develop methods to detect stress levels in real-time during surgical procedures to help monitor surgeon performance and mitigate the potential risk to the patients.

More specifically, with the development of modern robotic-assisted surgical platforms, the kinematic data can be collected directly from robot joint encoders without additional sensors. The real-time detection of stress levels using kinematic data of surgical robot end-effectors can be integrated with the advanced control techniques on robotic-assisted surgical platforms to provide the surgeon with stress coping strategies.

### Motivation for Recurrent Neural Networks

Predictive modeling based on machine learning or deep learning methods has been widely used in the field of surgical skill assessment, such as k-NearestNeighbors (kNN), logistic regression (LR) and support vector machines (SVM) [42,57]. Wang et al. [58] used a convolutional neural network (CNN) architecture for real-time surgical skill assessment. These techniques used motion data as input and validated the fact that motion data can be used for characterizing surgical performance. For stress detection, Pandey used several machine learning techniques (SVM, Logistic Regression) and heart rate as the input feature to predict patient acute stress condition.

With recent development in machine learning and deep learning, Recurrent Neural Networks (RNN), in particular, Long Short Term Memory (LSTM) models, have been shown to have important advantages in classifying and making predictions based on time-series data [44]. LSTM is an appropriate tool for temporal modeling and it is widely used in human activity recognition (HAR) and language processing due to its inherent structure to “memorize” and “forget” important points within a sequence of data [49,51].

The advantages associated with handling time-series data using LSTM has attracted the attention of researchers in the field of surgical data science. DiPietro et al. [41] applied LSTM to joint segmentation and classification of surgical activities from robot kinematic data. Kannan et al. [45] presented a model of a combination of a convolutional neural network (CNN) and an LSTM network to process the video data for recognition of the type of a laparoscopic surgery (e.g. adrenalectomy, gastric bypass, cholecystectomy etc.).

Recently, the attentionmechanism has also been proposed for sequence modeling. Bahdanau et al. first introduced attention in machine translation where the output will focus its attention on a certain part of a sequence [35]. Neural networks have demonstrated performance improvements when integrated with an attention mechanism. Attention mechanisms has been widely used in variety of sequence modeling projects, such as machine translation [35,60], sentiment classification [47], time-series prediction [53], etc.

As inspired by these studies, we decided to move a step forward to using predictive modeling techniques and kinematic data to implement a near real-time detection of surgical stress levels. Our hypothesis is that the surgeon's stress level during laparoscopic surgery can be extracted from the instrument handles movements within a short period of observation. In this study, we first implemented an attention-based LSTM classifier to classify normal/stressed trials as well as obtained the movements which were most affected by the stress. Then, we implemented another LSTM classifier to detect normal/stress movements based on the attention obtained from the first step.

### Background and Preliminary Work

### Experiment and Dataset

We used a portion of the dataset which came from one of our previous studies [46,61]. 30 medical students (29 were right-handed and 1 was left-handed) at the University of Texas Southwestern Medical Center were recruited in this IRB approved study (UTD #14-57, UTSW STU #032015-053) and informed consent was obtained.

After informed consent, each subject participated in a 10-minute tutorial on the Fundamentals of Laparoscopic Surgery (FLS) peg transfer drill to be familiarized with the instruments and the requirements of the experimental task. Subjects were randomly assigned into a control (n=15) or stressed (n=15) group.

During the experiment, each subject was asked to complete a 6-minute peg transfer task on a FLS box trainer in a high-fidelity simulated operating room (one trial per subject). The FLS box trainer was placed in the abdominal sect. of a medical manikin which was draped. A pair of electromagnetic (EM) trackers were used to capture the time-series data of motions (FIG. 2a). The EM trackers were mounted to the handles of the laparoscopic instruments. The data was recorded at a frequency of 256 Hz from the EM trackers.

The data collected by the EM trackers included xₕ-, yₕ-, zₕ-positional coordinates in space and quaternions q₀-, q₁-, q₂-, q₃-. The position coordinates determined the instrument handle positions in space and the quaternions were used to determine the rotation matrix for calculating the 3 dimensional instrument tip positions (xₜ-, yₜ-, zₜ-). The instrument tip positions were calculated using handle positions, a rigid body transformation obtained by quarternions and the instrument geometry. Both instrument handle and instrument tip positions were saved in the dataset.

The stressors in the study included the vital signs of the medical manikin and the moderator's feedback during the task. In control group, each subject proceeded while hearing normal vital signs and with no feedback from the moderator. What is worthy mentioning is, in stressed group, each subject performed the task under a period of progressively deteriorating vital signs, with a particular increase in intensity beginning at the 3-minutemark. Themoderator also provided feedback to the stressed subject and the feedback culminated in 30 seconds of cardiac arrest and the expiration of the medical manikin.

Besides the kinematic data from EM trackers, other data was collected and evaluated through video review, such as number of pegs transferred, number of errors made. Additionally, a blinded, independent reviewer with training in OSATS scoring graded each subject using a modified OSATS (mOSATS) rubric [48]. The subjects were also brought to complete the State-Trait-Anxiety-Inventory (STAI) to measure subjective stress after the experiment [55].

Overall, in this study, we only used the kinematic portion of our previously collected dataset. The dataset in this study contains the time-series 3-D positional data of both instrument handles (xₕ-, yₕ-, zₕ-) of each subject throughout the 6-minute peg transfer task. We removed the data of one subject (in control group, right-handed) due to sensor failure during experiment. We down-sampled the data to 5 Hz and organized the data of both instrument handles based on each subject's handedness, so the overall dataset of 29 subjects resulted in approximately 52,200 samples of six features x_{ND}, y_{ND}, z_{ND}, x_{D}, y_{D}, z_{D} (the subscript D is Dominant hand and ND is Nondominant hand).

### Previous Results

In our previous studies, we calculated the kinematic metrics of the instrument tips, such as velocity, acceleration, and jerk. We also analyzed the scores obtained by mOSATS and STAI. Statistical analysis comparing the metrics between control and stressed groups was conducted.

According to our previous studies evaluating the experimental data, in general, the stressed group had higher velocity, acceleration, jerk, indicating less smooth movements on instrument tips; Smaller numbers of pegs transferred, larger numbers of error made, lower mOSATS scores and higher scores for the change from baseline (trait) to during the scenario (state) in STAI.

The significant differences between control and stressed groups in our previous studies indicated that kinematic data can be related to increased stress levels. The detailed results of these evaluations can be found in our previous studies [46,61].

### Methods

### Trial-Wise Classification and Attention

It was not known if all movements made by the subject within a trial would have been affected by the external stress. The goal of this step is to find the importance of each time step within a trial that contributes to the stress representation. In other words, we want to extract the movements that are more significantly affected by the stress.

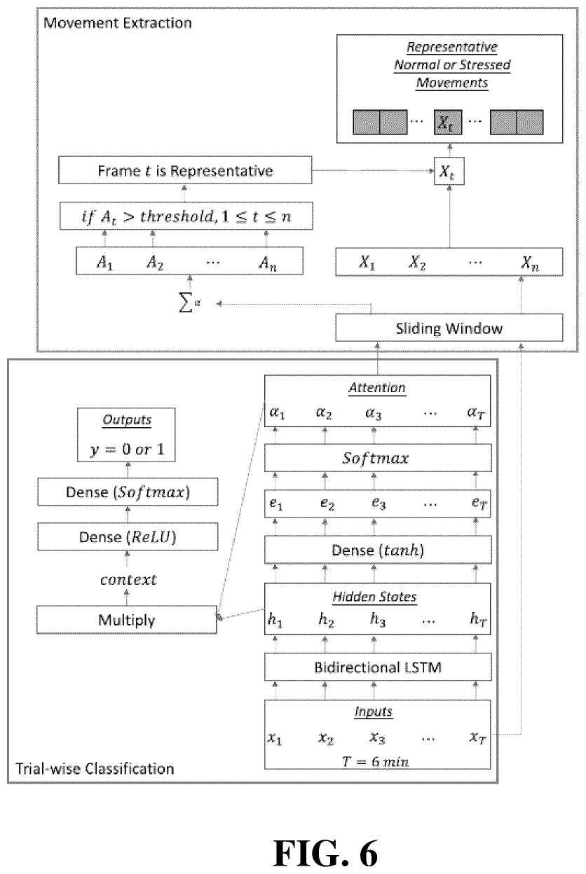

The architecture of the proposed attention-based LST classifier is shown in FIG. 6. The input sequence {x₁, x₂, . . . x_{T}} was the kinematic data of each trial. As mentioned in Sect. 3.1, the input kinematic data contains six features of the 3D positional data of both instrument handles ( ). For each input:

$$xi = {[ {x}_{NDi} , {y}_{NDi} , {z}_{NDi} , {x}_{Di} , {y}_{Di} , {z}_{Di} ]}^{T} , i = 1 … T \qquad ( 1 )$$

The subscript D is dominant hand side and ND is don-dominant hand side. The ground-truth label y={0 or 1} was assigned to be control (normal) or stressed trials. The input sequence {x1, x2 . . . , xT} was then fed into a Bidirectional LSTM to get the hidden state sequence h={h1, h2, . . . , hT}. Then we measured the importance of each time step by computing a tanh function of hidden states h:

$$e = tanh ( h ) = tanh ( {h}_{1} , {h}_{2} , … , {h}_{T} ) \qquad ( 2 )$$

e is called “energy” which can be interpreted as the contribution of the time step to the final representation of stress levels. The attention weights ai were obtained by passing eᵢ to a Sof tmax function, where ensured all attention weights of a trial sum to 1.

$${α}_{i} = \frac{exp ( {e}_{i} )}{{\sum }_{i = 1}^{n} exp ( {e}_{i} )} \qquad ( 3 )$$

The attention weight ai indicates how much attention the ground-truth label y should pay to the

i^{th} time step. Then we can calculate the context vector as a weighted linear combination of all hidden states h:

$$context = {\sum }_{i = 1}^{n} {α}_{i} {h}_{i} \qquad ( 4 )$$

Finally, two fully connected layers with activation functions of ReLU and Softmax were added. The context vector passed through the final layers and gave a prediction of y\hat{ }. Through model training and testing, we obtained the attention vector of each trial which was able to tell us which time steps were more important for classifying the trials as control (normal) or stressed.

### Movement Extraction

After obtaining the attention vector of each trial, we used a sliding window with a 50 m is the frame length. We also tested the performance of frame-wise classifier with different frame lengths (1 s, 2 s, 4 s, etc.) in the following sections. Then we calculated the third quartile of all Aₜ's in a trial as the threshold:

$${A}_{t} = \sum ( {α}_{i} , {α}_{i + 1} , … , {α}_{i + m - 1} ) \qquad ( 5 )$$

$$threshold = Q 3 ( {A}_{1} , {A}_{2} , … , {A}_{n} ) \qquad ( 6 )$$

n is the number of frames for each trial. Q3 is the third quartile. We considered any frame with an At >threshold to be “important” to reflect the effect of stress.

More specifically, a frame with an Aₜ>threshold in a control (normal) trial was considered to be a “representative” normal movement. Similarly, a frame with an Aₜ>threshold in a stressed trial was considered to be a “representative” stressed movement. Then, a subset of the original dataset containing the “representative” normal and stressed movements could be extracted based on the “important” frames for further classification (FIG. 6).

### Frame-Wise Classification

The training dataset of frame-wise classification is the “representative” normal and stressed movements extracted from Section 3.2.

The frame-wise classifier is a simple LSTM classifier which has an LSTM layer, a fully connected layer with the activation function of ReLU and a fully connected layer with the activation function of softmax to output the probability of a given data frame belonging to each of the 2 stress levels (normal or stressed).

We implemented the architectures of both models using Keras library based on Python 3.7 [39]. We tested the hyperparameters of the proposed networks by trial-and-error. The models were trained by minimizing the categorical cross entropy loss function between the predicted and ground-truth labels at a learning rate of 0.001, first and second momentum of 0.9 and 0.999, and weight decay of 10⁻⁸.

### Model Training and Validation

It is a standard practice to test the model by leaving aside a portion of the data as testing dataset, using the remaining portion for training. To evaluate the performance of our proposed classifiers, we adopted Leave-One-User-Out cross validation (LOUO). We used LOUO to test if the classifiers were generalized enough for unseen data. Our LOUO used the i^{th} subject as testing dataset and the rest for training, and iterated throughout all the 29 subjects. The mean values of all 29 iterations' performance metrics were reported and will be shown in the following sections.

### Performance Metrics

In classification, there are four common metrics for evaluating the performance of a classifier-Accuracy, Precision, Recall and F1-score. Accuracy is the ratio of correct predictions (Tp+Tn) to the total predictions (Tp+Fp+Tn+Fn); Precision is the ratio of correct positive predictions (Tp) to the total positive results (Tp+Fp) predicted by the classifier; Recall is the ratio of correct positive predictions (Tp) to the total actual results (Tp+Fn). F1-score is a measure of classifier's accuracy which takes the harmonic mean of the precision and recall.

$$Accuracy = \frac{{T}_{p} + {T}_{n}}{{T}_{p} + {F}_{p} + {T}_{n} + {F}_{n}} , \qquad ( 7 )$$

$$Precision = \frac{{T}_{p}}{{T}_{p} + {F}_{p}} , \qquad ( 8 )$$

$$Recall = \frac{{T}_{p}}{{T}_{p} + {F}_{n}} , \qquad ( 9 )$$

$$F 1 - score = \frac{2 ( Recall * Precision )}{Recall + Precision} . \qquad ( 10 )$$

### Results

To test the effectiveness of the proposed methods, we conducted the following analysis: (1) we evaluated the performance of our attention-based trial-wise classifier for evaluating the stress level of each trial; (2) we validated the attention vectors that were obtained from trial-wise classification and interpreted the practical meaning of attention based on the experimental designs; (3) we extracted the “representative” movements based on the attention vectors, and tested if these extracted movements were able to train the frame-wise classifier for detecting normal and stressed movements.

### Trial-Wise Classification and Attention

According to the experiment, each subject finished one 6-minute peg transfer trial under either control (normal) condition or stressed condition. We remove the data of one subject from the control group (right-handed) due to sensor failure during experiment, therefore resulting in a dataset of 14 subjects (or trials) in control group and 15 subjects (or trials) in stressed group.

First, we implemented the attention-based LSTM classifier to distinguish between control (normal) and stressed trials. We annotated the control (normal) trials as “0” and stressed trials as “1”. The input data was the kinematic data of each trial. After hyperparameter tuning, we obtained the performance metrics of this classifier under LOUO cross-validation scheme (Accuracy: 75.86%, Precision: 75.48%, Recall: 77.02%, F1-score: 76.24%).

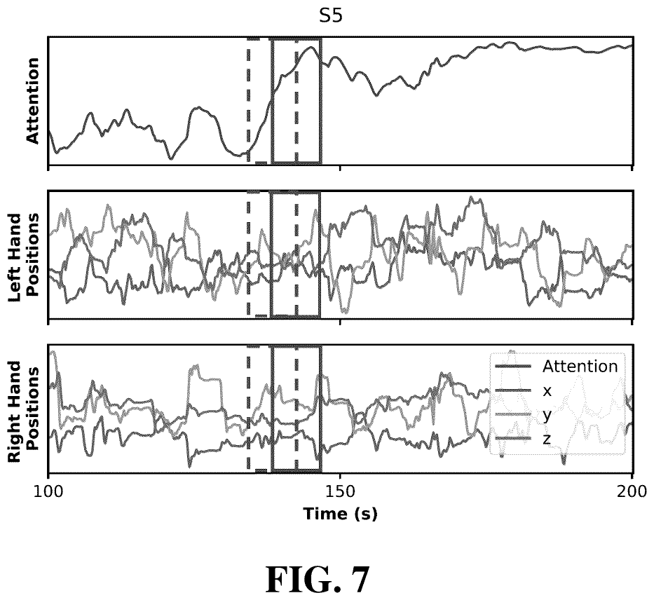

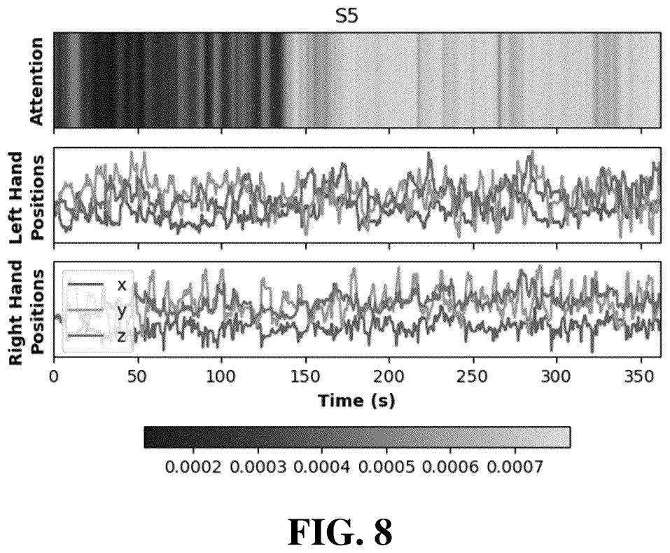

In addition, we also obtained the attention vector of each trial which indicated the contribution of each time step to the classification. We used the sliding-window to organized the attention into frames. The sum of attention of each frame was computed. The frames which had an attention sum greater than the 3rd quartile in each trial were considered to be representative normal or stressed movements (FIGS. 7 and 8).

### Validation of Attention Mechanism

We also divided the attention vector in stressed trials into first-3-minute and second-3-minute halves. We took the attention sums of these two halves and ran the ANOVAtest. The results showed that the attention sum of the second half in stressed trials was significantly greater than the attention sum of the first half in stressed trials (p=0.0386), which means the movements in second half contributed more to the classification of “stressed” and were more affected by the stressors.

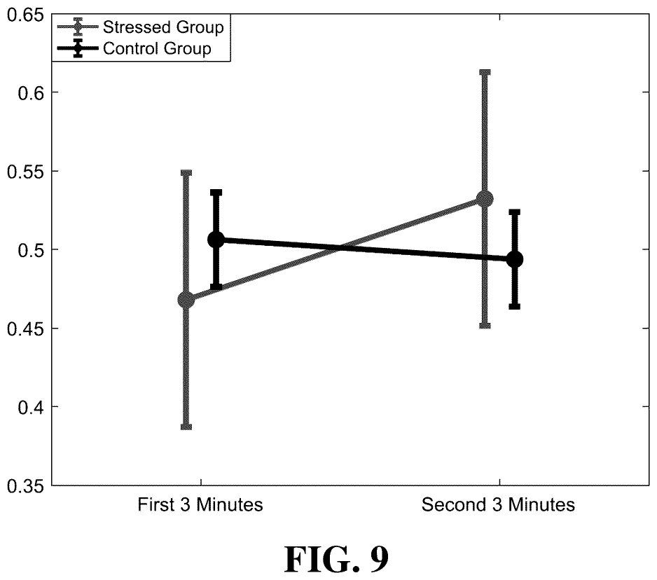

The same experiment was also conducted on the attention vector in control trials. The results showed that the attention sums of the first and second 3 minutes in control trials were not significantly different (p=0.2812), as shown in FIG. 9.

This finding is also consistent with our experimental design: the stressed group experienced increasingly intensive stressors in the second 3 minutes of each trial, therefore, validating the feasibility of the attention mechanism in this study.

### Movement Extraction and Classification

We implemented another simple LSTM model to classify the representative normal and stressed movements extracted from each trial based on attention. The training dataset contained the representative (high-attention) frames in control and stressed groups. Any frame had an attention sum greater than the 3rd quartile in a control trial was considered to be representative normal movements and any frame had an attention sum greater than the 3rd quartile in a stressed trial was considered to be representative stressed movements.

The frame sizes in classification using data streams play an important role as they need to contain enough information. In order to optimize the performance of our classifier, we repeated the training and LOUO cross-validation process with the data of four different frame sizes (1 s, 2 s, 4 s, 8 s, 16 s). Under LOUO cross-validation, the classification performance metrics were obtained. The frame size of 8 seconds showed the best results, as shown in Table 1 below: (Accuracy: 74.96).

TABLE 1
Performance summary of classification between “representa-
tive” normal and stressed movements under different frame sizes using
LOUO cross-validation. Bold column denotes the best results

| Metrics | 1s | 2s | 4s | 8s | 16s |
|---|---|---|---|---|---|
| Accuracy | 60.91 | 64.73 | 72.24 | 74.96 | 70.85 |
| Precision | 60.92 | 64.70 | 72.21 | 75.03 | 71.21 |
| Recall | 60.93 | 64.59 | 72.22 | 75.04 | 71.04 |
| F1-score | 60.93 | 64.65 | 72.22 | 75.04 | 71.13 |

### Frame-Wise Classification in Stressed Trials

As we mentioned in previous sections, the movements are not equally affected by the stressful condition which means that normal movements can still exist while the surgeon operating under stress. We have extracted “representative” normal and stressed movements from both control and stressed groups based on the attention vectors, and validated a classifier that could be used to distinguish between normal and stressed movements in Sect. 4.3. For this step, we test if these “representative” movements are applicable to classification between different movements in stressed trials. The training dataset contains the normal and stressed movements extracted from control and stressed trials, as mentioned in Sect. 4.3.

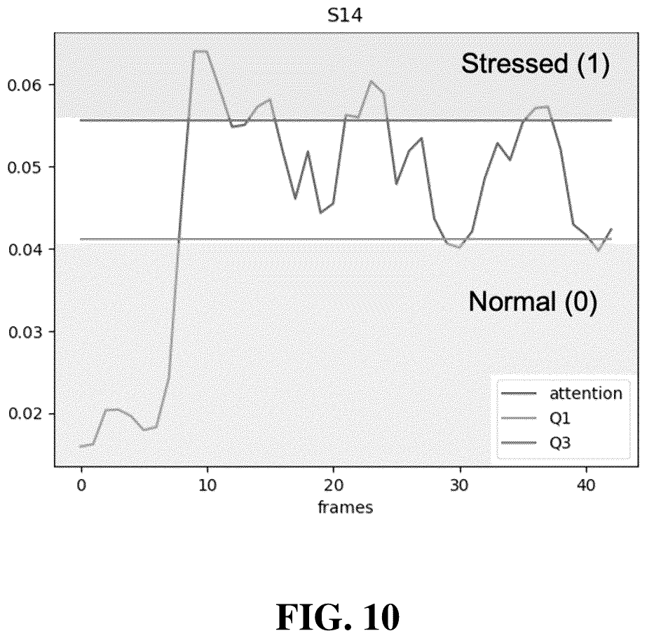

The testing dataset only contained the data of stressed trials. For ground-truth labeling in stressed trial (FIG. 10), we annotated the frame which had an attention sum greater than the third quartile of all attention sums in a trial as “stressed (1)”, and the frame which had an attention sum less than the first quartile of all attention sums in a trial as “normal (0)”.

We used the LOUO cross-validation to test the performance of frame-wise classifier. The i^{th} subject in stressed trial was used for testing. The training dataset should not include the data of the i^{th} subject. And the same process iterated throughout all 15 subjects in stressed group.

The LOUO cross-validation results are summarized in Table 2 below. The frame size of 16 seconds showed the best results (Accuracy: 68.18%, Precision: 68.30%, Recall: 68.18%, F1-score: 68.24%).

TABLE 2
Performance summary of classification between normal and
stressed movements in stressed trials under different frame sizes using
LOUO cross-validation. Bold column denotes the best results

| Metrics | 1s | 2s | 4s | 8s | 16s |
|---|---|---|---|---|---|
| Accuracy | 61.46 | 65.33 | 65.08 | 66.77 | 68.18 |
| Precision | 61.51 | 65.33 | 65.26 | 67.01 | 68.30 |
| Recall | 61.46 | 65.33 | 65.09 | 66.77 | 68.18 |
| F1-score | 61.48 | 65.33 | 65.17 | 66.89 | 68.24 |

### Discussion

Although many studies have been investigated surgeon stress levels and cognitive load during training, none of these studies have implemented stress detection in near real-time, to our knowledge. Prior studies have also included the recording and analysis of physiological data, for example, heart rate, heart rate variability, eye movements and skin conductance level in ways that can reflect subject stress levels directly; however, these methods require external sensors and are also not real-time. The goal of our study is to validate the feasibility of a neural network approach to enable near-real time stress level detection using only kinematic data.

LSTM Recurrent Neural Networks have been widely used for prediction with time-series data as the input. More specifically, the LSTM with attention mechanism has gained its popularity recently in the field of sequence to sequence (seq2seq) modeling, such as machine translation and semantic analysis. We started with an attention-based LSTM architecture to distinguish between the control (normal) and stressed trials as well as getting the attention vector for movement extraction and used another simple LSTM classifier to distinguish normal and stressed movements.

We validated our classifiers using a common cross validation method: LOUO cross-validation. The goal of LOUO cross-validation is to test if the model is generalized for unseen data, i.e. having a high accuracy with the data from a new (unseen) subject. For trial-wise classification, we obtained the accuracy of 75.86% under LOUO as well as the attention vector of each trial.

In terms of the frame sizes, we tested different frame sizes (1 s, 2 s, 4 s, 8 s, 16 s) for frame-wise classification. A larger frame size can have an improved performance in classification.

But the classifier performance decreases when the frame size continuously increases due to the fact that the LSTM can face challenges when handling longer sequences. Our proposed frame-wise classifier was able to distinguish between the “representative” normal and stressed movements with an accuracy of 74.96%; and an accuracy of 68.18% when the frame-wise classifier was applied to detecting normal and stressed movements within the stressed trials.

One limitation of this study is that we only tested a fixed size data frame. However, a surgical procedure consists of different surgical gestures, for example, moving, lifting and grasping, with different lengths of time period. Different kinds of surgical gestures could be affected by the surgical stressors differently. One direction of our future work is to overlap the attention vector on the recorded video, and extracted the surgical gestures that are significantly affected by the stressors. The second limitation of this study is the number of features. We only had 3D positional data as the input (x_{ND}, y_{ND}, z_{ND}, x_{D}, y_{D}, z_{D}). Especially, when we transplant this method to robot-assisted surgical systems where more information can be streamed, for example, rotation matrix, linear velocities and angular velocities, recruiting a variety of kinematic data may help improve the overall performance of our proposed method. Another limitation of the experiment is the lack of expertise levels and baseline data collection. We only had medical students recruited and only one trial (control or stressed) for each subject in the study. A better generalization can be made if subjects included attending, fellow, and resident surgeons in a large number, as well as baseline trials prior to the experiment to wash out the individual's inherent psychomotor skills.

It is worth noting that we used the kinematic data on instrument handles (xh-, yh-, zh-) in this study. There are several reasons why we used the data on instrument handles: First, handles motion could better capture the hands motion as shown in FIG. 2a; Second, our long term goal is to provide stress coping strategies on robot-assisted surgical platforms where we can provide haptics on surgeon-side manipulators based on the kinematic data of hands motion. Therefore, one direction of future work is to conduct a similar experiment using a robot-assisted surgical platform, such as da Vinci Research Kit (dVRK), to study the differences of identifying stressed conditions between conventional laparoscopic surgery and robot-assisted laparoscopic surgery.

### Conclusion

In this study, we developed a deep learning model to extract and detect stressed movements from kinematic data during laparoscopic surgical training tasks. We first validated an attention-based LSTM model for classification of normal/stressed surgical training trials. Based on the attention, we were able to extract the typical movements that contributed to the classification of each trial. Finally, we validated another simple LSTM classifier and we were able to distinguish between the normal and stressed movements using a short period of data. We tested the model under LOUO cross-validation scheme, and it showed that the model was generalized to unseen data.

Our proposed method has the following advantages for surgical stress detection: First, only kinematic data was used. Unlike physiological sensing techniques, kinematic sensing does not require the subject to wear sensors, especially in robot-assisted surgical systems. Second, our frame-wise classifier takes a short period of movement as input and outputs its stress level. This frame-wise classification enables near real-time detection of stress level during surgical procedures. Finally, our model avoids feature extraction prior to feeding data to the model. Using the raw data can potentially expedite detection to near real-time.

Our proposed model has the ability of high accuracy and fast computational speed which is suitable for near real time detection of surgical stress level using kinematic data. Future experiments should be done to study the detection of stress on a robot-assisted surgical platform due to the inherent differences between convention laparoscopic surgery and robot-assisted laparoscopic surgery, for example, motion scaling and fulcrum effects. We believe that this study paved way for continued research on mitigating the negative effect of surgical stress on robot-assisted surgical systems where the kinematic data can be streamed directly.

### Determining the Significant Kinematic Features for Characterizing Stress During Surgical Tasks Using Spatial Attention

It has been shown that intraoperative stress can have a negative effect on surgeon surgical skills during laparoscopic procedures. For novice surgeons, stressful conditions can lead to significantly higher velocity, acceleration, and jerk of the surgical instrument tips, resulting in faster but less smooth movements. However, it is still not clear which of these kinematic features (velocity, acceleration, or jerk) is the best marker for identifying the normal and stressed conditions. Therefore, in order to find the most significant kinematic feature that is affected by intraoperative stress, we implemented a spatial attention-based Long-Short-Term-Memory (LSTM) classifier. In a prior IRB approved experiment, we collected data from medical students performing an extended peg transfer task who were randomized into a control group and a group performing the task under external psychological stresses. In our prior work, we obtained “representative” normal or stressed movements from this dataset using kinematic data as the input.

In this study, a spatial attention mechanism is used to describe the contribution of each kinematic feature to the classification of normal/stressed movements. We tested our classifier under Leave-One-User-Out (LOUO) cross-validation, and the classifier reached an overall accuracy of 77.11% for classifying “representative” normal and stressed movements using kinematic features as the input. More importantly, we also studied the spatial attention extracted from the proposed classifier. Velocity and acceleration on both sides had significantly higher attention for classifying a normal movement (p<=0.0001); Velocity (p<=0.015) and jerk (p<=0.001) on non-dominant hand had significant higher attention for classifying a stressed movement, and it is worth noting that the attention of jerk on non-dominant hand side had the largest increment when moving from describing normal movements to stressed movements (p=0.0000). In general, we found that the jerk on non-dominant hand side can be used for characterizing the stressed movements for novice surgeons more effectively.

Excessive intraoperative stress can have a negative effect on surgeon technical skills and therefore compromise patient safety [62-65]. Laparoscopic surgery, in particular, represents a very complex motor control learning task [66], and it has been shown that external stressors can adversely affect motor performance [67]. Detecting the presence of operative stress and its potential detrimental effect on motor performance is an important problem for the surgical training community. Conventional methods for measuring human stress have included physiological sensing techniques such as measuring cortisol levels, heart rate, heart rate variability, and skin conductance levels [68-72]. In practice, physiological sensing techniques can be invasive, time consuming, and may require surgeons to wear sensors on their bodies that could interfere with the technical performance.

Alternatively, kinematic data promises to be a less invasive measurement technique than physiological sensing techniques as this data can be measured directly from robotic encoders in the case of robotic surgery, or through the use of computer vision [73] or other simple sensors [75]. Kinematic data has also been shown to be a powerful tool in other types of surgical skill evaluation [75-77]. For example, Wang et al. implemented a convolutional neural network and used kinematic data as input for real-time surgical skill assessment [78]. In our recent studies, we have validated the feasibility of using kinematic features of the laparoscopic instrument tips (velocity, acceleration and jerk) to distinguish between stressed and non-stressed (normal) conditions during laparoscopic training tasks using statistical analysis. The results indicated that the subjects had significantly higher velocity, acceleration, and jerk in both non-dominant and dominant hand sides when they were under stressed conditions [74, 79]. However, it is not clear which kinematic features can best characterize stressed conditions. In other words, our goal in this study is to find the kinematic feature of novice surgeons' movements which is most affected by external stressors as this data stream could hold the most promise for real-time stress detection and mitigation measures.

Deep learning algorithms, such as the attention mechanism with Recurrent Neural Networks (RNN) and, in particular, Long-Short-Term-Memory (LSTM) models [80] could help identify the best metrics for stress identification. LSTM can overcome the limitations in traditional RNNs, for example, traditional RNNs have a problem of vanishing gradients and thus are not able to capture long term dependencies [81]. The attention mechanism in LSTM can select more critical information from numerous input features [82]. Recently, the attention mechanism has been widely used in a variety of sequence modeling projects, such as machine translation [83,84] and sentiment classification [85]. Qin et al. introduced a dual-stage attention-based Long-Short-Term-Memory (LSTM) model for time-series forecasting [86]. According to this study, the first stage was an input attention mechanism, or spatial attention mechanism, to adaptively extract relevant input features at each time step. Li et al. implemented a novel RNN-based spatial attention model for human manipulation skill assessment from video input. The attention in videos helped them focus on critically important video regions for better skill assessment [87]. In the field of robotic-assisted surgery, Qin et al. implemented a dual-stage attention-based LSTM model for predicting surgical movements and surgical states [88]. As inspired by these studies using attention mechanisms on input features, we chose to implement a spatial attention-based LSTM classifier to extract the most important kinematic features for characterizing either a normal or a stressed movement.

With the recent development of robotics-assisted surgical platforms, the kinematic data can be streamed directly from encoders on robot joints without any additional sensors. More importantly, the actuated surgeon side end-effectors could be used for advanced control techniques to provide the surgeon with stress coping strategies in the form of force feedback applied by the surgeon side end effectors to the surgeon's hands while the surgeon side end effectors are controlled by surgeons to teleoperate the patient side end-effectors [89], for example, slowing down or pausing [90]. Once we are able to find the kinematic feature which can describe the stressed movements most significantly, the slowing down haptic strategies for coping with external stress can be designed based on this significant kinematic feature.

### 2. Background and Previous Work

We have raised a question before the study: “What characterizes a stressful movement and how do we detect it?” In order to answer this question, we conducted an experiment in which subjects were provided with commonly experienced intraoperative stressors while performing surgical training tasks in a randomized fashion [74, 79]. Then we studied the negative effect of stressors as well as implementing a deep learning algorithm to extract and detect the stressed movements. The details of this experiment will be summarized in Section 2.1.

### 2.1 Identifying Stress

### 2.1.1 Experimental Design

In this experiment, 30 medical students (29 were righthanded and 1 was left-handed) at the University of Texas Southwestern Medical Center were recruited. The study was IRB approved and informed consent was obtained (approved by UTD IRB office (UTD #14-57) and UTSW IRB offices (STU #032015-053)). Each subject completed a 10-minute tutorial on the FLS peg transfer task to be familiarized with the instruments and the requirements of the experiment. Then the subjects were randomly divided into a control (n=15) group or stressed (n=15) group. The random number sequence for control/stressed group assignment was generated using the random number generator in R programming language. The subject recruiter and the person who analyzed the data were separate. Therefore, it prevented the individuals analyzing the data from knowing which group a subject was assigned to in advance.

During the experiment, each subject was required to finish a 6-minute peg transfer task on the FLS trainer which was placed in the abdominal section of a medical manikin. A pair of electromagnetic (EM) trackers were mounted to the handles of the laparoscopic instruments to capture the time-series data of movements. We used the trakSTARTM electromagnetic 6 DoF tracking system from Ascension Technology Corporation. The data collected by the EM trackers included xₕ, yₕ, zₕ positional coordinates in space and quaternions q₀, q₁, q₂, q₃ at a frequency of 256 Hz. The instrument tip positions were calculated using the handle positions (xₕ, yₕ, zₕ), a rigid body transformation obtained by handle rotations (q₀, q₁, q₂, q₃) and the instrument geometry.

The stressors in this study included the vital signs of the medical manikin and the moderator's feedback during the task. In the control group, each subject proceeded while hearing normal vital signs and with no feedback from the moderator. In the stressed group, each subject performed the task under a period of progressively deteriorating vital signs, with a distinct increase in intensity beginning at the 3-minute mark (the middle point of the 6-minute task). The moderator provided feedback to the stressed group and the feedback culminated in 30 seconds of cardiac arrest and the expiration of the medical manikin.

Besides the kinematic data from EM trackers, other data was collected and evaluated through video review, such as the number of pegs transferred and the number of errors made. Additionally, a blinded independent reviewer with training in OSATS scoring graded each subject using a modified OSATS (mOSATS) rubric [30]. mOSATS is a subsection of OSATS including respect for tissue (RFT), time and motion (TM), instrument handling (IH) and the total score (TOT). The subjects also completed a State-Trait-Anxiety-Inventory (STAI) to measure subjective stress after the experiment [94].

### 2.1.1.2 Previous Results

We removed the data of one subject (in the control group, right-handed) due to the loss of connections between sensors and computer during the experiment. We down-sampled the kinematic data to 5 Hz to remove noise and smooth the data and organized the data of both instrument tips based on each subject's handedness, so the overall dataset of 29 subjects resulted in approximately 52,200 samples of six features x_{ND}, y_{ND}, z_{ND}, x_{D}, y_{D}, z_{D} (the subscript D indicates data from the dominant hand and ND is non-dominant hand) [93]. After down-sampling the data, the kinematic metrics velocity (V), acceleration (A) and jerk (J) of the instrument tips were also calculated:

$${V}_{t} = \frac{\sqrt{{( {P}_{t + 1} - {P}_{t} )}^{T} ( {P}_{t + 1} - {P}_{t} )}}{{T}_{t + 1} - {T}_{t}} \qquad ( 1 )$$

Pₜ is the 3-D position at time t, and Tₜ is the timestamp at time t. The Acceleration (A) and the jerk (J) were time-series data calculated in a similar way:

$${A}_{t} = \frac{{V}_{t + 1} - {V}_{t}}{{T}_{t + 1} - {T}_{t}} , {J}_{t} = \frac{{A}_{t + 1} - {A}_{t}}{{T}_{t + 1} - {T}_{t}} \qquad ( 2 )$$

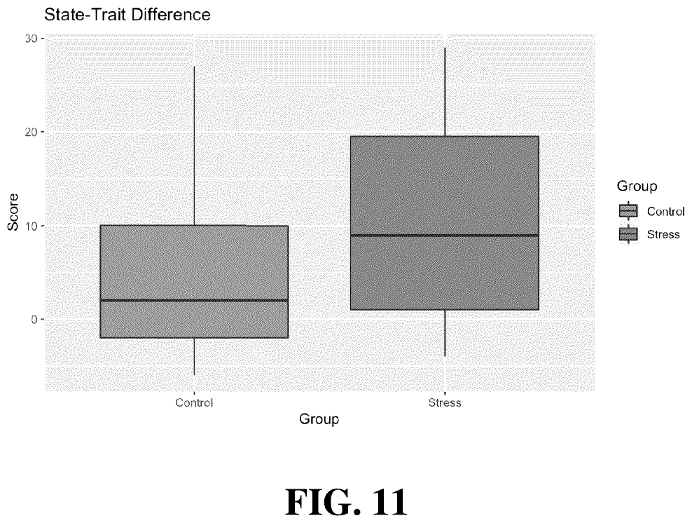

The stressed group had significantly higher velocity, acceleration, and jerk than the control group for both hands. In the stressed group, the second 3-minute half of the experiment had significantly higher velocity, acceleration, jerk, path length and lower economy of volume than the first 3-minute half for both hands. Other standard metrics were also analyzed, for example, the stressed group had fewer pegs transferred and larger errors, indicating worse performance under stressful conditions [74]. Lower mOSATS scores and higher scores for the change from baseline (trait) to during the scenario (state) in STAI were found to be significant in the stressed group (FIG. 11). These significant differences between control and stressed groups in our studies indicated that the kinematic data can be related to increased stress levels.

We also extracted the movements that were more significantly affected by the stress using a temporal attention-based LSTM classifier in another study [94]. We first implemented a trial-wise classifier with the attention mechanism which took the time-series instrument tips positional data (x_{ND}, y_{ND}, z_{ND}, x_{D}, y_{D}, z_{D}) of each trial as the input, and returned y=0:control (normal) or y=1: stressed as the output. The classifier returned the temporal attention for each trial, which was a vector containing the importance of each time step within a trial that contributed to classification of control or stressed trial. After obtaining the temporal attention vector of each trial, we used a sliding window to organize the temporal attention sequence and the input sequence into frames. We calculated the sum of each attention frame and considered any frame with an attention greater than the third quartile to be “important”: a frame with an attention sum greater than the third quartile in a control (normal) trial was considered to be a “representative” normal movement; A frame with an attention sum greater than the third quartile in a stressed trial was considered to be a “representative” stressed movement.

Finally, a subset of the original dataset containing the “representative” normal and stressed movements could be extracted based on the temporal attention.

### 2.2 Goals of This Study

With the first question mentioned in the first paragraph of Section 2.1 answered by our studies in Section 2.1.2, we decided to move forward to finding the answers of a second question: “Which kinematic features are most important to identify the onset of stress?”

Even through the results in Section 2.1.2 indicate that stress leads to significantly higher velocity, acceleration and jerk in novice surgeons' movements, it is still not clear that which kinematic feature has more contribution for identifying the stressed movements and therefore, could be a potential candidate to be improved though novel haptic cues.

### 3. Methods

In this study, the kinematic features (velocity, acceleration and jerk) of the obtained “representative” movements were used as the input of our newly proposed spatial attention-based LSTM classifier.

The classifier returns: first, whether a movement is a normal or a stressed movement; second, the spatial attention vector that describes the importance of each input feature (velocity, acceleration and jerk) that contributes to the classification of a normal/stressed movement. Instead of capturing the importance of each time step, namely temporal attention as described in previous sections, spatial-attention calculates the importance of each input feature at each time step for classification [86].

### 3.1 Model Architecture

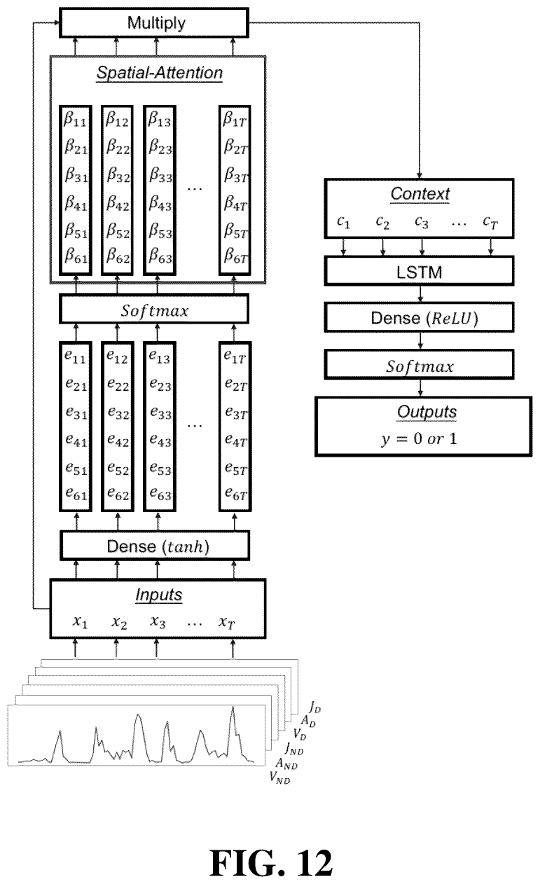

The architecture of the proposed spatial attention-based LSTM classifier is illustrated in FIG. 12. The input sequence {x1, x2, . . . , xT} was the kinematic features of each “representative” movement. As mentioned above, each x contained six kinematic features extracted from both instrument tips, velocity, acceleration and jerk, respectively (V_{ND}, A_{ND}, J_{ND}, V_{D}, A_{D}, J_{D}). For each input:

$${x}_{j} = [ {V}_{NDj} , {A}_{NDj} , {J}_{NDj} , {V}_{Dj} , {A}_{Dj} , {J}_{Dj} ] T , j = 1 … T \qquad ( 3 )$$

The subscript D is the dominant hand side and ND is the non-dominant hand side. The ground truth label y=0 or 1 was assigned to be either a “representative” control (normal) movement or a “representative” stressed movement.

We measured the importance of each input feature by computing a tanh function of input x with units=6:

$${e}_{ij} = tanh ( {x}_{j} ) = tanh ( {x}_{1 j} , {x}_{2 j} , … , {x}_{3 j} ) , i = 1 , … , 6 \qquad ( 4 )$$

eᵢⱼ was called “energy” which calculated the contribution of each feature at each time step j to the final classification of control (normal) or stressed movement.

Then, the spatial attention weights βᵢⱼ at each time step j were obtained by passing eij to a Softmax function to ensure all spatial attention weight as each time step sum to 1:

$${β}_{ij} = \frac{exp ( {e}_{ij} )}{{\sum }_{i = 1}^{n} exp ( {e}_{ij} )} \qquad ( 5 )$$

The spatial attention weight βᵢⱼ indicates how much attention the final output label y should pay to the i^{th} input feature at time step j.

Next, we calculated the context vector (c₁, c₂, . . . , c_{T}) as a weighted linear combination of all input features at each time step xᵢ:

$${c}_{i} = {\sum }_{i = 1}^{6} {β}_{ij} {x}_{ij} \qquad ( 6 )$$

Finally, we passed the context vector to an LSTM (units=100). The final output of LSTM was sent to two fully-connected layers with activation functions of ReLU, units=20 and Softmax, units=2 to output the prediction y\hat{ }. The hyperparameters in the model were selected through grid search. During grid search, we shuffled and split the data into the training set and testing set using a 70/30 split. Then, we chose the set of hyperparameters which showed the best accuracy in grid search for classifier design.

Different from grid search, we adopted Leave-One-User-Out cross-validation to evaluate the performance of our proposed model which will be described in Section 3.2.

We obtained two outputs from the proposed classifier. First, a classification result of the input movement deciding whether the input movement was normal or stressed. Second, the spatial attention vector that could tell the importance of each input feature to classify the movements as normal or stressed movements.

### 3.2 Cross-Validation

To evaluate the performance of our proposed classifier, we adopted Leave-One-User-Out (LOUO) cross-validation. The LOUO used the i^{th} subject as testing dataset and the rest for training, and iterated throughout all the 29 subjects. The mean values of all 29 iterations' performance metrics were reported and will be shown in the following sections. LOUO was designed to test if the classifiers were generalized enough for unseen data.

### 3.3 Model Performance Metrics

To evaluate the performance of our proposed classifier, four commonly used metrics were used in our study-Accuracy, Precision, Recall, and F1-score. Accuracy is the ratio of correct predictions (Tp+Tn) to the total predictions (Tp+Fp+Tn+Fn); Precision is the ratio of correct positive predictions (Tp) to the total positive results (Tp+Fp) predicted by the classifier; Recall is the ratio of correct positive predictions (Tp) to the total actual results (Tp+Fn). F1-score is a measure of a classifier's accuracy which takes the harmonic mean of the precision and recall.

$$Accuracy = \frac{{T}_{p} + {T}_{n}}{{T}_{p} + {F}_{p} + {T}_{n} + {F}_{n}} , \qquad ( 7 )$$

$$Precision = \frac{{T}_{p}}{{T}_{p} + {F}_{p}} , \qquad ( 8 )$$

$$Recall = \frac{{T}_{p}}{{T}_{p} + {F}_{n}} , \qquad ( 9 )$$

$$F 1 - score = \frac{2 ( Recall * Precision )}{Recall + Precision} . \qquad ( 10 )$$

### 4. Results and Discussion

To investigate which kinematic features can potentially characterize either a normal movement or a stressed movement for novice surgeons, we used the kinematic features of the “representative” movements as the input of our proposed spatial attention-based LSTM model. For each trial (or subject), there were 11 “representative” movements extracted by methods described in Section 2.1.2 and in [94]. The “representative” movements were sent into the classifier, resulting in 319 movements in total.

The dataset we used in this study was from our previous experiment which has been discussed in Section 2.1. In order to validate our approach, first, the performance of our proposed spatial attention-based LSTM classifier was evaluated. Second, the spatial attention of all six kinematic features were obtained from the proposed classifier. Data analysis was carried out to determine the significant differences among the spatial attention of all six kinematic features.

### 4.1 Classifier Performance

In this study, we aimed to classify between the “representative” normal/stressed movements using the kinematic features (velocity, acceleration and jerk). The input of our classifier was the kinematic features of each “representative” normal or stressed movement. And the output returned if the input was a normal movement (y=0) or a stressed movement (y=1) as well as the spatial attention vector describing the contribution of each kinematic feature.

Based on the previous study, the input movement length was 16 seconds [94]. Under LOUO cross-validation, we used the movements of the ith subject as the testing dataset and the remaining for training the model. And the same process iterated throughout all 29 subjects (11 movements from each subject). Accuracy was obtained through averaging throughout LOUO cross-validation (Mean: 77.11%, Standard Deviation: 17.32%). Since we were using LOUO and each User's movement could only be either normal or stressed, it was not appropriate to calculate Precision, Recall and F1-score individually. Instead, we added the confusion matrix of all LOUO iterations and used the summed confusion matrix for calculations (Precision: 77.26%, Recall: 77.23%, F1-score: 77.24%).

### 4.2 Spatial Attention of Kinematic Features

The classifier also returned the spatial attention vector β of each input feature that contributed to the classification. In other words, spatial attention tells us which kinematic features had the most potential to characterize either a normal or a stressed movement.

As described in Section 3.1, the classifier returns a vector of attention at each time step j for a given input movement ([β1j, β2j, β3j, β4j, β5j, β6j]T). In order to compare the attention among different kinematic features, we then took the average of the spatial attention across all time steps for each input movement. As a result, the averaged spatial attention of each kinematic feature across all time steps was used in statistical analysis to determine significant differences in the six kinematic features in normal and stressed movements. The normality test to identify a normal distribution in the averaged spatial attention was rejected and thus, the Kruskal Wallis test (kruskalwallis( ) function in MATLAB) was used to identify the significance. If the null hypothesis of Kruskal Wallis test was rejected, we used multicompare( ) function in MATLAB to determine the significant pairs within 6 kinematic features.

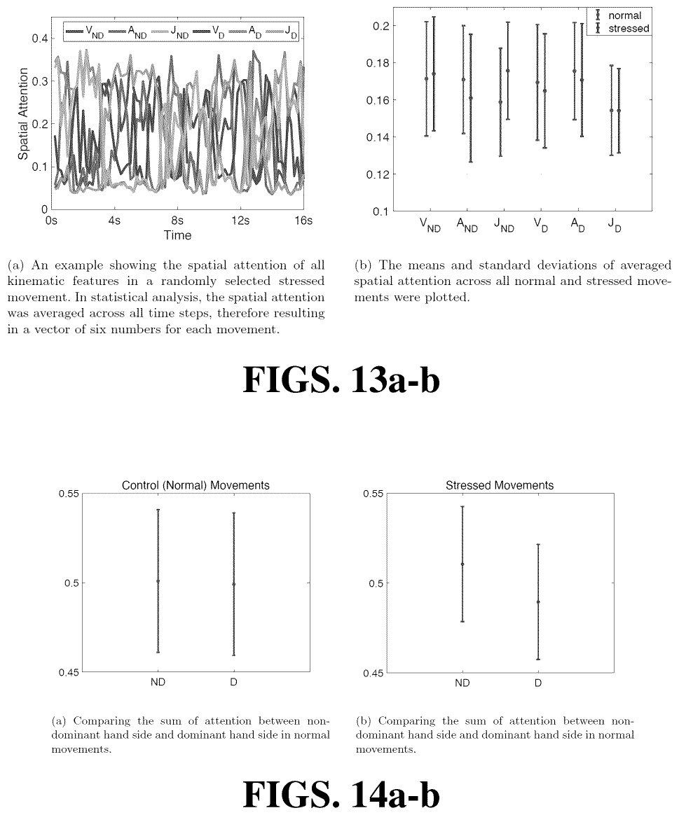

The spatial attention of each kinematic feature to describe a normal movement is shown in the blue lines in FIG. 13b. The results of statistical analysis to determine the differences among the six features are summarized in Table. 1 below. As shown in FIG. 13b and Table. 1 below, the velocity and acceleration for both non-dominant (V_{ND}, A_{ND}) and dominant (V_{D}, A_{D}) hand sides had significantly higher attention than the jerk (J_{ND} and J_{D}) in normal movements. It means that the velocity and acceleration have more potential to describe a normal movement.

TABLE 1
Normal movements: statistical analysis summary
of the spatial attention of six kinematic features.

| | Significance | p-value |
|---|---|---|
| Kinematic | V_{ND} > J_{ND}, J_{D} | p < 0.0001 |
| Features | A_{ND} > J_{ND}, J_{D} | p = 0.0001 |
| | V_{D} > J_{ND}, J_{D} | p = 0.0001 |
| | A_{D} > J_{ND}, J_{D} | p < 0.0001 |
| ND vs. D | N/A | p = 0.8198 |

However, in stressed movements, as shown in the red lines in FIG. 13b and Table. 2 below, velocity and jerk on the nondominant hand side (V_{ND}, J_{ND}) had significantly higher attention than acceleration on non-dominant hand side (A_{ND}), velocity and jerk on the dominant hand side (V_{D} and J_{D}). Besides, according to Table. 2, acceleration on the dominant hand side (A_{D}) also showed significantly higher attention than jerk on the dominant hand side (J_{D}). The results indicate that velocity and jerk on non-dominant hand side and acceleration on the dominant hand side have a better potential to describe a stressed movement.

TABLE 2
Stressed movements: statistical analysis summary
of the spatial attention of six kinematic features.

| | Significance | p-value |
|---|---|---|
| Kinematic | V_{ND} > A_{ND}, V_{D}, J_{D} | p < 0.015 |
| Features | J_{ND} > A_{ND}, V_{D}, J_{D} | p < 0.001 |
| | A_{D} > J_{D} | p = 0.0002 |
| ND vs. D | ND > D | p < 0.0001 |

When comparing the kinematic feature attentions between normal movements and stressed movements in FIG. 13b, we noticed that the attention values of V_{ND}, V_{D} and J_{D} did not show a clear difference between normal and stressed movements. However, the attention value of J_{ND} had a clear difference when describing normal movements to describing stressed movements. It means that J_{ND} received a higher attention from the classifier when describing a stressed movement. Similarly, the attention values of A_{ND} and A_{D} had a clear difference when describing stressed movements to describing the normal movements. It means that A_{ND} and A_{D} received a higher attention when describing a normal movement. Then, we used a Wilcoxon rank sum test to compare the attention of each kinematic feature between normal and control movements for both hand sides in Table. 3 below. Therefore, we can say that J_{ND} was mostly affected by the stress, and it can be used to characterize the stress more effectively; A_{ND} and A_{D} can be used to characterize the normal movements.

TABLE 3
Comparisons of the spatial attention of kinematic
features between normal and stressed movements.

| Kinematic Features | Significance | p-value |
|---|---|---|
| V_{ND} | N/A | p = 0.9821 |
| A_{ND} | Normal > Stressed | p = 0.023 |
| J_{ND} | Normal < Stressed | p = 0.0000 |
| V_{D} | N/A | p = 0.0724 |
| A_{D} | Normal > Stressed | p = 0.0002 |
| J_{D} | N/A | p = 0.8388 |

### 4.3. Spatial Attention of Non-Dominant and Dominant Hand Sides

We also examined the importance of hand sides to characterize the normal or stressed movement. Instead of analyzing the spatial attention of each kinematic feature separately, we took the sum of the spatial attention of kinematic features of both non-dominant hand side and dominant hand side.

As shown in FIG. 14a and the last row of Table. 1, no significant difference between non-dominant hand side and dominant hand side can be found. It means the movement on both sides has equal importance for describing a normal condition. This finding is easy to be explained since in normal movements, the subjects were performing under normal conditions and the movements on both sides were not affected by the intraoperative stressors, so there is no difference between the two hands.

However, in stressed movements, where the subjects' performance was negatively affected by the stressors, the importance of both sides to characterize the stressed movements has changed. As shown in FIG. 14b and the last row of Table. 2, the non-dominant hand side showed significantly higher attention than the dominant hand side which means the kinematic features on the non-dominant hand side have more potential to characterize the stressed movements. The reason behind this finding is that the movement on the non-dominant hand side is less skilled and less dexterous. Interestingly, recent work from our lab has also shown that when two hands are moving simultaneously, the non-dominant hand actually suffers in performance relative to if it was moving alone [95]. We think these results could indicate that because the non-dominant hand is arguably the weaker of the two hands, studying its movements is useful as it is more prone to performance degradations in challenging conditions. Therefore, the movement on the non-dominant hand side is more likely to be negatively affected by the intraoperative stressors and it is reflected as a higher attention on the non-dominant hand side during classification of stressed movements.

### 5. Conclusion

In this study, we implemented a spatial attention-based LSTM model and used kinematic features (velocity, acceleration and jerk) as input for the classification of “representative” normal and stressed movements which were obtained from our previous studies [74, 94].

Our proposed classifier was able to distinguish between “representative” normal and stressed movement with an accuracy of 77.11% under LOUO cross-validation, and it showed that our classifier was generalized to unseen data. More importantly, the classifier also returned the spatial attention vector which was able to tell us the contribution of each kinematic feature to the final classification labels.

We also conducted statistical analysis to study the obtained spatial attention of six kinematic features. In normal movements, velocity and acceleration on both nondominant and dominant hand sides had significantly higher attention than jerk. It means that velocity and acceleration contributed more to the classification of a normal movement, and therefore, can be used for characterizing a normal movement.

In stressed movements, velocity and jerk on the nondominant hand side had significantly higher attention than acceleration on non-dominant hand side, velocity and jerk on dominant hand side. Although it is not significant, the jerk also had higher attention than velocity on nondominant hand side.

When comparing the kinematic feature attentions between normal and stressed movements in FIG. 13b and Table. 3, we noticed that the attention of the jerk on nondominant hand side had the significant change when moving from normal movement to stressed movement. It means that jerk on the non-dominant hand side was the most significant kinematic feature to be affected by stress, therefore, had the best potential for characterizing a stressed movement. Similarly, in normal movements, the acceleration on both hand sides also had significantly higher spatial attention than stressed movements, which means the accelerations had the best potential for characterizing a normal movement.

We also conducted analysis based on non-dominant and dominant hand sides. In normal movements, the spatial attention sums on both sides did not show any significant differences. However, in stressed movements, the non-dominant hand side had significantly higher spatial attention than the dominant hand side which means the kinematic features on non-dominant hand side had better potential to describe a stressed movement and the performance of non-dominant hand is more likely to be negatively affected by intraoperative stress.

One limitation of this study is the lack of expertise levels. We only had medical students recruited and only one trial (control or stressed) for each subject. A better generalization of this deep learning approach can be made if subjects could include a wider range of expertise levels, for example, attending, fellow and resident surgeons in a large number, therefore, reducing the probability of overfitting the model.

In general, in this paper, we answered the question raised in Section 2.2: “Which type of haptic cues on telerobotic platforms could improve the stressful movements significantly?”. Based on the results, in novice surgeons' movements, the jerk on non-dominant hand and the accelerations on both hand sides are most likely to be affected by stress. And according to our previous study, the stress led to significantly greater values of jerk meaning less smooth movements under stressed conditions. These findings can be integrated to create haptic cues based on jerk, especially on non-dominant hand side on telerobotic platforms to help novice surgeons cope with intraoperative stress and therefore, mitigate the negative effect of stress. In future work, we will need to determine how to develop an effective haptic feedback cue that can mitigate changes in movement jerk. This is not a trivial problem as jerk-based measurements are prone to noise and it is not clear how to provide jerk-based haptic feedback in a stable way.

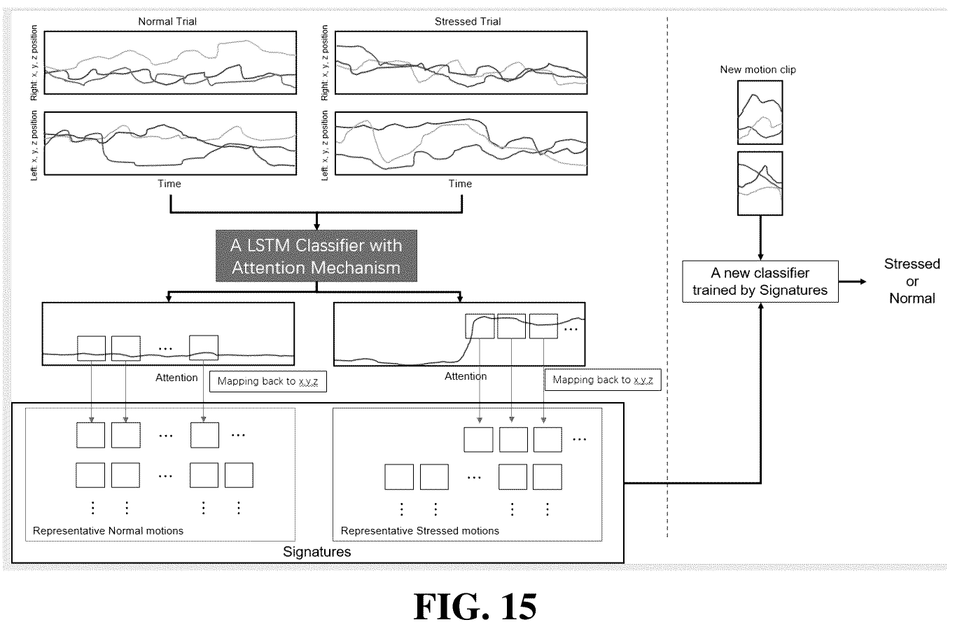

FIG. 15 illustrates a flowchart of the steps for using normal and stressed trial data to obtain a representative normal and representative stressed model for training a new classifier according to an exemplary embodiment of the present disclosure.

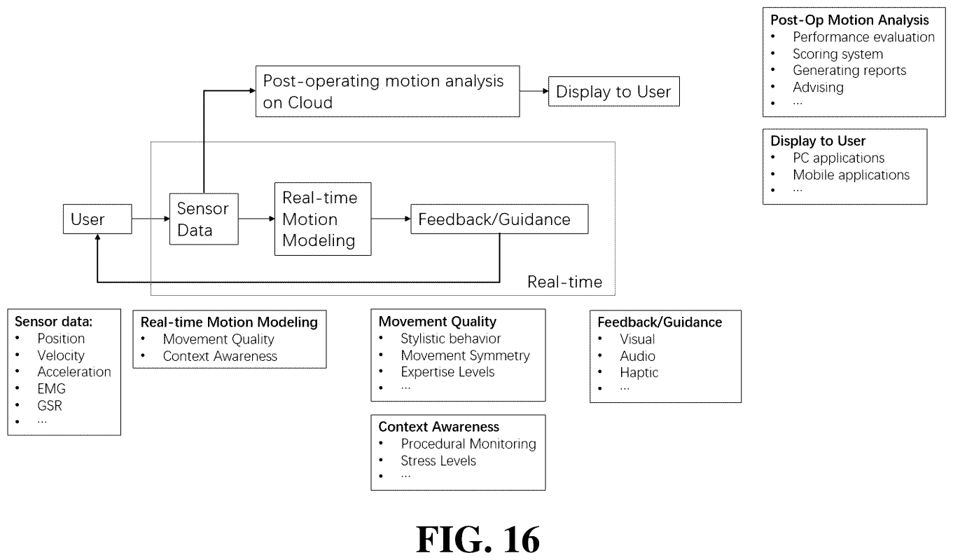

FIG. 16 illustrates sensor data and movement models can be used for feedback and guidance to a user according to an exemplary embodiment of the present disclosure.

### REFERENCES

The contents of the following references are incorporated by reference herein:

### REFERENCES

[1] N. E. Anton, P. N. Montero, L. D. Howley, C. Brown, and D. Stefanidis, “What stress coping strategies are surgeons relying upon during surgery?” in American Journal of Surgery, vol. 210, no. 5. Elsevier Inc., November 2015, pp. 846-851.
[2] R. Berguer, W. D. Smith, and Y. H. Chung, “Performing laparoscopic surgery is significantly more stressful for the surgeon than open surgery,” Surgical Endoscopy, vol. 15, no. 10, pp. 1204-1207, 2001.
[3] R. Berguer, G. T. Rab, H. Abu-Ghaida, A. Alarcon, and J. Chung, “A comparison of surgeons' posture during laparoscopic and open surgical procedures,” Surgical Endoscopy, vol. 11, no. 2, pp. 139-142, 1997.
[4] A. G. Gallagher, N. McClure, J. McGuigan, K. Ritchie, and N. P. Sheehy, “An ergonomic analysis of the fulcrum effect in the acquisition of endoscopic skills,” Endoscopy, vol. 30, no. 7, pp. 617-620, 1998.
[5] R. Berguer and W. Smith, “An Ergonomic Comparison of Robotic and Laparoscopic Technique: The Influence of Surgeon Experience and Task Complexity,” Journal of Surgical Research, vol. 134, no. 1, pp. 87-92, July 2006.
[6] Z. Wang, M. Kasman, M. Martinez, R. Rege, H. Zeh, D. Scott, and A. M. Fey, “A comparative human-centric analysis of virtual reality and dry lab training tasks on the da vinci surgical platform,” Journal of Medical Robotics Research, vol. 4, no. 03n04, p. 1942007, 2019.
[7] E. D. Ryan, “Effects of stress on motor performance and learning,” Research Quarterly. American Association for Health, Physical Education and Recreation, vol. 33, no. 1, pp. 111-119, 1962.
[8] S. Arora, N. Sevdalis, D. Nestel, T. Tierney, M. Woloshynowych, and R. Kneebone, “Managing intraoperative stress: what do surgeons want from a crisis training program?” American Journal of Surgery, vol. 197, no. 4, pp. 537-543, April 2009.
[9] K. Moorthy, Y. Munz, A. Dosis, S. Bann, and A. Darzi, “The effect of stress-inducing conditions on the performance of a laparoscopic task,” Surgical Endoscopy and Other Interventional Techniques, vol. 17, no. 9, pp. 1481-1484, sep 2003.
[10] K. H. Goodell, C. G. Cao, and S. D. Schwaitzberg, “Effects of cognitive distraction on performance of laparoscopic surgical tasks,” Journal of Laparoendoscopic and Advanced Surgical Techniques, vol. 16, no. 2, pp. 94-98, April 2006.
[11] S. Arora, N. Sevdalis, R. Aggarwal, P. Sirimanna, A. Darzi, and R. Kneebone, “Stress impairs psychomotor performance in novice laparoscopic surgeons,” Surgical Endoscopy, vol. 24, no. 10, pp. 2588-2593, 2010.
[12] C. M. Wetzel, R. L. Kneebone, M. Woloshynowych, D. Nestel, K. Moorthy, J. Kidd, and A. Darzi, “The effects of stress on surgical performance,” American Journal of Surgery, vol. 191, no. 1, pp. 5-10, January 2006.
[13] K. Moorthy, Y. Munz, D. Forrest, V. Pandey, S. Undre, C. Vincent, and A. Darzi, “Surgical crisis management skills training and assessment: A stimulation-based approach to enhancing operating room performance,” Annals of Surgery, vol. 244, no. 1, pp. 139-147, July 2006.
[14] A. Yamamoto, T. Hara, K. Kikuchi, T. Hara, and T. Fujiwara, “Intraoperative stress experienced by surgeons and assistants,” Ophthalmic Surgery and Lasers, vol. 30, no. 1, pp. 27-30, January 1999.
[15] C. M. Wetzel, S. A. Black, G. B. Hanna, T. Athanasiou, R. L. Kneebone, D. Nestel, J. H. Wolfe, and M. Woloshynowych, “The effects of stress and coping on surgical performance during simulations,” Annals of surgery, vol. 251, no. 1, pp. 171-176, 2010.
[16] J. A. Martin, G. Regehr, R. Reznich, H. Macrae, J. Murnaghan, C. Hutchison, and M. Brown, “Objective structured assessment of
[19] S. Yamaguchi, D. Yoshida, H. Kenmotsu, T. Yasunaga, K. Konishi, S. Ieiri, H. Nakashima, K. Tanoue, and M. Hashizume, “Objective assessment of laparoscopic suturing skills using a motion-tracking system,” Surgical Endoscopy, vol. 25, no. 3, pp. 771-775, 2011. technical skill (OSATS) for surgical residents,” British Journal of Surgery, vol. 84, no. 2, pp. 273-278, February 1997.
[17] S. Cotin, N. Stylopoulos, M. Ottensmeyer, P. Neumann, D. Rattner, and S. Dawson, “Metrics for Laparoscopic Skills Trainers: The Weakest Link!” in Medical Image Computing and Computer-Assisted Intervention—MICCAI 2002, T. Dohi and R. Kikinis, Eds. Berlin, Heidelberg: Springer Berlin Heidelberg, 2002, pp. 35-43.
[18] V. Datta, S. Mackay, M. Mandalia, and A. Darzi, “The use of electromagnetic motion tracking analysis to objectively measure open surgical skill in the laboratory-based model,” Journal of the American College of Surgeons, vol. 193, no. 5, pp. 479-485, November 2001.
[20] I. Oropesa, P. S'anchez-Gonzalez, M. K. Chmarra, P. Lamata, A'. Fernandez, J. A. Sa'nchez-Margallo, F. W. Jansen, J. Dankelman, F. M. S'anchez-Margallo, and E. J. G'omez, “EVA: Laparoscopic instrument tracking based on endoscopic video analysis for psychomotor skills assessment,” Surgical Endoscopy, vol. 27, no. 3, pp. 1029-1039, oct 2013.
[21] J. A. S'anchez-Margallo, F. M. S'anchez-Margallo, . . . . I. Oropesa, S. Enciso, and E. J. G'omez, “Objective assessment based on motion-related metrics and technical performance in laparoscopic suturing,” Int J CARS, vol. 12, pp. 307-314, 2017.
[22] T. N. Judkins, D. Oleynikov, and N. Stergiou, “Objective evaluation of expert and novice performance during robotic surgical training tasks,” Surgical Endoscopy and Other Interventional Techniques, vol. 23, no. 3, pp. 590-597, March 2009.
[23] B. B\ddot{ }ohm, N. R\ddot{ }otting, W. Schwenk, S. Grebe, and U. Mansmann, “A prospective randomized trial on heart rate variability of the surgical team during laparoscopic and conventional sigmoid resection,” Archives of Surgery, vol. 136, no. 3, pp. 305-310, 2001.
[24] E. Czyzewska, K. Kiczka, A. Czarnecki, and P. Pokinko, “The surgeon's mental load during decision making at various stages of operations,” European Journal of Applied Physiology and Occupational Physiology, vol. 51, no. 3, pp. 441-446, 1983.
[25] A. P. Tendulkar, G. P. Victorino, T. J. Chong, M. K. Bullard, T. H. Liu, and A. H. Harken, “Quantification of surgical resident stress “on call”,” Journal of the American College of Surgeons, vol. 201, no. 4, pp. 560-564, October 2005.
[26] W. Boucsein, Electrodermal activity: Second edition. Springer US, August 2012, vol. 9781461411.
[27] W. D. Smith, Y. H. Chung, and R. Berguer, “A virtual instrument ergonomics workstation for measuring the mental workload of performing video-endoscopic surgery,” in Studies in Health Technology and Informatics, vol. 70. IOS Press, 2000, pp. 309-315.
[28] Z. Wang and A. Majewicz Fey, “Deep learning with convolutional neural network for objective skill evaluation in robot-assisted surgery,” International Journal of Computer Assisted Radiology and Surgery, vol. 13, no. 12, pp. 1959-1970, dec 2018.
[29] L. Tao, E. Elhamifar, S. Khudanpur, G. D. Hager, and R. Vidal, “Sparse hidden Markov models for surgical gesture classification and skill evaluation,” in Lecture Notes in Computer Science (including subseries Lecture Notes in Artificial Intelligence and Lecture Notes in Bioinformatics), vol. 7330 LNCS. Springer, Berlin, Heidelberg, 2012, pp. 167-177.
[30] M. J. Fard, S. Ameri, R. Darin Ellis, R. B. Chinnam, A. K. Pandya, and M. D. Klein, “Automated robot-assisted surgical skill evaluation: Predictive analytics approach,” International Journal of Medical Robotics and Computer Assisted Surgery, vol. 14, no. 1, February 2018.
[31] M. Quigley, K. Conley, B. Gerkey, J. Faust, T. Foote, J. Leibs, R. Wheeler, and A. Ng, “Ros: an open-source robot operating system,” vol. 3, January 2009.
[32] Anton N E, Montero P N, Howley L D, Brown C, Stefanidis D (2015) What stress coping strategies are surgeons relying upon during surgery? Am J Surg 210:846-851
[33] Arora S, Sevdalis N, Nestel D, Tierney T, Woloshynowych M, Kneebone R (2009) Managing intraoperative stress: what do surgeons want from a crisis training program? AmJ Surg 197(4):537-543. https://doi.org/10.1016/j.amjsurg.2008.02.009
[34] Arora S, Sevdalis N, Aggarwal R, Sirimanna P, Darzi A, Kneebone R (2010) Stress impairs psychomotor performance in novice laparoscopic surgeons. Surg Endosc 24(10):2588-2593
[35] Bahdanau D, Cho K H, Bengio Y (2015) Neural machine translation by jointly learning to align and translate. In: 3rd international conference on learning representations, ICLR 2015-Conference track proceedings, International conference on learning representations, ICLR, 1409.0473
[36] Berguer R, Smith W D, Chung Y H (2001) Performing laparoscopic surgery is significantly more stressful for the surgeon than open surgery. Surg Endosc 15(10): 1204-1207
[37] Böhm B, Rötting N, Schwenk W, Grebe S, Mansmann U (2001) A prospective randomized trial on heart rate variability of the surgical team during laparoscopic and conventional sigmoid resection. Arch Surg 136(3):305-310
[38] Boucsein W (2012) Electrodermal activity. Springer, US
[39] Chollet F (2015) Keras. https://github.com/fchollet/keras
[40] Czyzewska E, Kiczka K, Czarnecki A, Pokinko P (1983) The surgeon's mental load during decision making at various stages of operations. Eur J Appl Physiol 51(3):441-446
[41] DiPietro R, Lea C, Malpani A, Ahmidi N, Vedula S S, Lec G I, Lec M R, Hager G D (2016) Recognizing surgical activities with recurrent neural networks. In: Ourselin S, Joskowicz L, Sabuncu M R, Unal G, Wells W (eds) Medical image computing and computer-assisted intervention-MICCAI 2016. Springer International Publishing, Cham, pp 551-558
[42] Fard M J, Ameri S, Darin Ellis R, Chinnam R B, Pandya A K, Klein M D (2018) Automated robot-assisted surgical skill evaluation: predictive analytics approach. Int J Med Robot Comput Assisted Surg. https://doi.org/10.1002/rcs.1850
[43] Goodell K H, Cao C G, Schwaitzberg S D (2006) Effects of cognitive distraction on performance of laparoscopic surgical tasks. J Laparoendosc Adv Surg Tech 16(2):94-98. https://doi.org/10. 1089/lap.2006.16.94
[44] Hochreiter S, Schmidhuber J (1997) Long short-term memory. Neural Comput 9(8): 1735-1780
[45] Kannan S, Yengera G, Mutter D, Marescaux J, Padoy N (2020) Future-state predicting LSTM for early surgery type recognition. IEEE Trans Med Imag 39(3):556-566
46. Leonard G, Cao J, Scielzo S, Zheng Y, Tellez J, Zch H J, Fey A M (2020) The effect of stress and conscientiousness on simulated surgical performance in unbalanced groups: a Bayesian Hierarchical Model. J Am Coll Surg 231(4):S258. https://doi.org/10.1016/j.jamcollsurg.2020.07.397
47. Ma D, Li S, Zhang X, Wang H (2017) Interactive attention networks for aspect-level sentiment classification. In: Proceedings of 2018 10th international conference on knowledge and systems engineering, KSE2018 pp 25-30, http://arxiv.org/abs/1709.00893, 1709.00893
[48] Martin J A, Regehr G, Reznich R, Macrae H, Murnaghan J, Hutchison C, Brown M (1997) Objective structured assessment of technical skill (OSATS) for surgical residents. Br J Surg 84(2):273-278. https://doi.org/10.1046/j.1365-2168.1997.02502.x
[49] Milenkoski M, Trivodaliev K, Kalajdziski S, Jovanov M, Stojkoska B R (2018) Real time human activity recognition on smartphones using LSTM networks. In: 2018 41st International convention on information and communication technology, electronics and microelectronics, MIPRO 2018-Proceedings, Institute of Electrical and Electronics Engineers Inc., pp 1126-1131
[50] Moorthy K, Munz Y, Dosis A, Bann S, Darzi A (2003) The effect of stress-inducing conditions on the performance of a laparoscopic task. Surg Endosc Other Interv Tech 17(9): 1481-1484
[50] Nammous M K, Saced K (2019) Natural language processing: Speaker, language, and gender identification with LSTM. In: Advances in intelligent systems and computing, Springer Verlag, vol 883, pp 143-156, https://doi.org/10.1007/978-981-13-3702-4_9
[52] Pandey P S (2017) Machine Learning and IoT for prediction and detection of stress. In: Proceedings of the 2017 17th International conference on computational science and its applications, ICCSA 2017, Institute of electrical and electronics engineers Inc., https://doi.org/10.1109/ICCSA.2017.8000018
[53] Qin Y, Feyzabadi S, Allan M, Burdick J W, Azizian M (2020) da VinciNet: Joint prediction of motion and surgical state in robot-assisted surgery. arXiv http://arxiv.org/abs/2009.11937, 2009.11937
[54] Ryan E D (1962) Effects of stress on motor performance and learning. Research quarterly. Am Assoc Health, Phys Educ Recreat 33(1): 111-119
[55] Sielberger C, Gorsuch R, Vagg P, Jacobs G (1983) Manual for the state-trait anxiety inventory (form y)
[56] Tendulkar A P, Victorino G P, Chong T J, Bullard M K, Liu T H, Harken A H (2005) Quantification of surgical resident stress oncall. J Am College Surg 201(4):560-564
[57] Vedula S S, Malpani A, Ahmidi N, Khudanpur S, Hager G, Chen C C G (2016) Task-level vs. segment-level quantitative metrics for surgical skill assessment. J Surg Educ 73(3):482-489
[58] Wang Z, Majewicz Fey A (2018) Deep learning with convolutional neural network for objective skill evaluation in robot-assisted surgery. Int J Comput Assisted Radiol Surg. https://doi.org/10. 1007/s11548-018-1860-1
[59] Weenk M, Alken A P, Engelen L J, Bredie S J, van de Belt T H, van Goor H (2018) Stress measurement in surgeons and residents using a smart patch. Am J Surg 216(2):361-368
[60] Zhang B, Xiong D, Su J (2020) Neural machine translation with deep attention. IEEE Trans Pattern Anal Mach Intell 42(1):154-163. https://doi.org/10.1109/TPAMI.2018.2876404
[61] Zheng Y, Leonard G, Zeh H, Tellez J, Majewicz Fey A (2021) Identifying kinematicmarkers associated with intraoperative stress during surgical training tasks. In: IEEE International Symposium on Medical Robotics (ISMR), pp 1-7
[62] S. Arora, N. Sevdalis, R. Aggarwal, P. Sirimanna, A. Darzi and R. Kneebone, Stress impairs psychomotor performance in novice laparoscopic surgeons, Surgical Endoscopy 24(10) (2010) 2588-2593.
[63] S. Arora, N. Sevdalis, D. Nestel, T. Tierney, M. Woloshynowych and R. Kneebone, Managing intraoperative stress: what do surgeons want from a crisis training program?, American Journal of Surgery 197 (April 2009) 537-543.
[64] K. Moorthy, Y. Munz, A. Dosis, S. Bann and A. Darzi, The effect of stress-inducing conditions on the performance of a laparoscopic task, Surgical Endoscopy and Other Interventional Techniques 17 (September 2003) 1481-1484.
[65] K. H. Goodell, C. G. Cao and S. D. Schwaitzberg, Effects of cognitive distraction on performance of laparoscopic surgical tasks, Journal of Laparoendoscopic and Advanced Surgical Techniques 16 (April 2006) 94-98.
[66] E. N. Spruit, G. P. Band, J. F. Hamming and K. R. Ridderinkhof, Optimal training design for procedural motor skills: a review and application to laparoscopic surgery, Psychological research 78(6) (2014) 878-891.
[67] E. D. Ryan, Effects of stress on motor performance and learning, Research Quarterly. American Association for Health, Physical Education and Recreation 33(1) (1962) 111-119.
[68] B. J. van Holland, M. H. Frings-Dresen and J. K. Sluiter, Measuring short-term and long-term physiological stress effects by cortisol reactivity in saliva and hair, International archives of occupational and environmental health 85(8) (2012) 849-852.
[69] B. B\ddot{ }ohm, N. R\ddot{ }otting, W. Schwenk, S. Grebe and U. Mansmann, A prospective randomized trial on heart rate variability of the surgical team during laparoscopic and conventional sigmoid resection, Archives of Surgery 136(3) (2001) 305-310.
[70] E. Czyzewska, K. Kiczka, A. Czarnecki and P. Pokinko, The surgeon's mental load during decision making at various stages of operations, European Journal of Applied Physiology and Occupational Physiology 51(3) (1983) 441-446.
[71] A. P. Tendulkar, G. P. Victorino, T. J. Chong, M. K. Bullard, T. H. Liu and A. H. Harken, Quantification of surgical resident stress “on call”, Journal of the American College of Surgeons 201 (October 2005) 560-564.
[72] W. Boucsein, Electrodermal activity (Springer Science & Business Media, 2012).
[73] F. Chadebecq, F. Vasconcelos, E. Mazomenos and D. Stoyanov, Computer vision in the surgical operating room, Visceral Medicine 36(6) (2020) 456-462.
[74] Y. Zheng, G. Leonard, J. Tellez, H. Zeh and A. M. Fey, Identifying kinematic markers associated with intraoperative stress during surgical training tasks, 2021 International Symposium on Medical Robotics (ISMR), IEEE (2021), pp. 1-7.
[75] M. J. Fard, S. Ameri, R. Darin Ellis, R. B. Chinnam, A. K. Pandya and M. D. Klein, Automated robot assisted surgical skill evaluation: Predictive analytics approach, The International Journal of Medical Robotics and Computer Assisted Surgery 14 (February 2018) p. e1850.
[76] S. S. Vedula, A. Malpani, N. Ahmidi, S. Khudanpur, G. Hager and C. C. G. Chen, Task-Level vs. Segment-Level Quantitative Metrics for Surgical Skill Assessment, Journal of Surgical Education 73 (May 2016) 482-489.
[77] M. Ershad, R. Rege and M. Fey, A., Meaningful assessment of robotic surgical style using the wisdom of crowds, International Journal of Computer Assisted Radiology and Surgery 13 (2018) 1037-1048.
[78] Z. Wang and A. M. Fey, Deep learning with convolutional neural network for objective skill evaluation in robot-assisted surgery, International journal of computer assisted radiology and surgery 13(12) (2018) 1959-1970.
[79] G. Leonard, J. Cao, S. Scielzo, Y. Zheng, J. Tellez, H. J. Zeh and A. M. Fey, The Effect of Stress and Conscientiousness on Simulated Surgical Performance in Unbalanced Groups: A Bayesian Hierarchical Model, Journal of the American College of Surgeons 231 (October 2020) p. S258.
[80] S. Hochreiter and J. Schmidhuber, Long Short-Term Memory, Neural Computation 9 (November 1997) 1735-1780.
[81] Y. Bengio, P. Simard and P. Frasconi, Learning longterm dependencies with gradient descent is difficult, IEEE transactions on neural networks 5(2) (1994) 157-166.
[82] Y. Ding, Y. Zhu, J. Feng, P. Zhang and Z. Cheng, Interpretable spatio-temporal attention LSTM model for flood forecasting, Neurocomputing 403 (August 2020) 348-359.
[83] D. Bahdanau, K. H. Cho and Y. Bengio, Neural machine translation by jointly learning to align and translate, 3rd International Conference on Learning Representations, ICLR 2015-Conference Track Proceedings, (International Conference on Learning Representations, ICLR, September 2015).
[84] B. Zhang, D. Xiong and J. Su, Neural Machine Translation with Deep Attention, IEEE Transactions on Pattern Analysis and Machine Intelligence 42 (January 2020) 154-163.
[85] D. Ma, S. Li, X. Zhang and H. Wang, Interactive attention networks for aspect-level sentiment classification, Proceedings of the 26th International Joint Conference on Artificial Intelligence, (2017), pp. 4068-4074.
[86] Y. Qin, D. Song, H. Cheng, W. Cheng, G. Jiang and G. W. Cottrell, A Dual-Stage Attention-Based Recurrent Neural Network for Time Series Prediction, IJCAI International Joint Conference on Artificial Intelligence 0 (April 2017) 2627-2633.
[87] Z. Li, Y. Huang, M. Cai and Y. Sato, Manipulation skill assessment from videos with spatial attention network, 2019 IEEE/CVF International Conference on Computer Vision Workshop (ICCVW), IEEE (2019), pp. 4385-4395.
[88] Y. Qin, S. Feyzabadi, M. Allan, J. W. Burdick and M. Azizian, davincinet: Joint prediction of motion and surgical state in robot-assisted surgery, 2020 IEEE/RSJ International Conference on Intelligent Robots and Systems (IROS), IEEE pp. 2921-2928.
[89] N. Enayati, A. M. Okamura, A. Mariani, E. Pellegrini, M. M. Coad, G. Ferrigno and E. De Momi, Robotic Assistance-as-Needed for Enhanced Visuomotor Learning in Surgical Robotics Training: An Experimental Study (Institute of Electrical and Electronics Engineers Inc., September 2018), pp. 6631-6636.
[90] N. E. Anton, P. N. Montero, L. D. Howley, C. Brown and D. Stefanidis, What stress coping strategies are surgeons relying upon during surgery?, American Journal of Surgery, 210, (Elsevier Inc., November 2015), pp. 846-851.
[91] J. A. Martin, G. Regehr, R. Reznich, H. Macrae, J. Murnaghan, C. Hutchison and M. Brown, Objective structured assessment of technical skill (OSATS) for surgical residents, British Journal of Surgery 84 (February 1997) 273-278.
[92] C. Sielberger, R. Gorsuch, P. Vagg and G. Jacobs, Manual for the state-trait anxiety inventory (form y) (1983).
[93] T. N. Judkins, D. Oleynikov and N. Stergiou, Objective evaluation of expert and novice performance during robotic surgical training tasks, Surgical Endoscopy and Other Interventional Techniques 23 (March 2009) 590-597.
[94] Y. Zheng, G. Leonard, H. Zeh and A. M. Fey, Framewise detection of surgeon stress levels during laparoscopic training using kinematic data, International Journal of Computer Assisted Radiology and Surgery (2022) 1-10.
[95] J. R. Boehm, N. P. Fey and A. M. Fey, Effects of scaling and sequence on performance of dynamic bimanual path following tasks, Journal of Medical Robotics Research 5(03n04) (2020) p. 2042001.

1. A method for stress detection using kinematic data, wherein the method comprises:
inputting the kinematic data into a model;
determining if the kinematic data from a user belong to a class of sub-movements associated with known signatures found to highly correlate with when the user is experiencing motor degradation due to high psychological stress versus a normal class of movements where the user is unaffected by stress; and
training the model by iteratively updating parameters of the model to minimize error between a prediction and a ground-truth label through backpropagation.

2. The method of claim 1 wherein the parameters comprise weights and biases.

3. The method of claim 2 wherein the weights and biases are in cells of a long-short-term-memory (LSTM) recurrent neural network.

4. The method of claim 3 wherein the weights and biases are in fully-connected layers.

5. The method of any one of claim 4 wherein the backpropagation comprises:
(1) inputting the kinematic data to the model to make the prediction;
(2) calculating the error between the prediction and the ground-truth label;
(3) propagating the error backwards through the LSTM recurrent neural network and fully-connected layers; and
(4) updating the weights and biases of the model using optimization methods.

6. The method of claim 5 further comprising repeating steps (1)-(4) multiple times.

7. The method of claim 6 wherein steps (1)-(4) are repeated until the error between the prediction and ground-truth label in minimized.

8. The method of claim 2 wherein an importance is assigned to different time steps in an input sequence of kinematic data.

9. The method of claim 8 wherein the importance is assigned to different time steps in the input sequence of kinematic data based on the relevance of the importance to a final classification task.

10. A system for stress detection using kinematic data, wherein the system if configured to:
input the kinematic data into a model;
determine if the kinematic data from a user belong to a class of sub-movements associated with known signatures found to highly correlate with when the user is experiencing motor degradation due to high psychological stress versus a normal class of movements where the user is unaffected by stress; and
train the model by iteratively updating parameters of the model to minimize error between a prediction and a ground-truth label through backpropagation.

11. The system of claim 10 wherein the parameters comprise weights and biases.

12. The system of claim 11 wherein the weights and biases are in cells of a long-short-term-memory (LSTM) recurrent neural network.

13. The system of claim 12 wherein the weights and biases are in fully-connected layers.

14. The system of claim 3 wherein the system is configured to perform the backpropagation by:
(1) inputting the kinematic data to the model to make the prediction;
(2) calculating the error between the prediction and the ground-truth label;
(3) propagating the error backwards through the LSTM recurrent neural network and fully-connected layers; and
(4) updating the weights and biases of the model using optimization methods.

15. The system of claim 14, wherein the system is configured to repeat steps (1)-(4) multiple times.

16. The system of claim 15 wherein the system is configured to repeat steps (1)-(4) until the error between the prediction and ground-truth label in minimized.

17. The system of claim 11 wherein the system is configured to assign an importance to different time steps in an input sequence of kinematic data.

18. The system of claim 17 wherein the system is configured to assign the importance to different time steps in the input sequence of kinematic data based on the relevance of the importance to a final classification task, including also detecting signatures associated with stress onset that enhance performance rather than degrade it.
